(19) United States
(12) Patent Application Publication
(10) Pub. No.: US 2025/0252385 A1
(43) Pub. Date: Aug. 7, 2025

(54) SYSTEMS AND METHODS FOR USING ARTIFICIAL INTELLIGENCE AND MACHINE LEARNING TO GENERATE OPTIMIZED OPERATING PARAMETERS FOR A WORK TOOL BASED ON TRACK HAPTIC FEEDBACK AND QUALITY OF JOB PERFORMED

(71) Applicant: BlueForge Alliance, Bryan, TX (US)

(72) Inventor: Arnold Kravitz, St. Petersburg, FL (US)

(73) Assignee: BlueForge Alliance, Bryan, TX (US)

(21) Appl. No.: 19/187,202

(22) Filed: Apr. 23, 2025

Related U.S. Application Data
(63) Continuation-in-part of application No. 18/394,298, filed on Dec. 22, 2023.
(60) Provisional application No. 63/607,354, filed on Dec. 7, 2023.
(60) Provisional application No. 63/640,658, filed on Apr. 30, 2024.

(51) Int. Cl. G06Q 10/0639; G06F 3/01; G06Q 10/04

(52) U.S. Cl. CPC G06Q 10/06398; G06F 3/011; G06F 3/016; G06Q 10/04

(57) ABSTRACT

Systems and methods for using artificial intelligence to generate optimized parameters for a work tool based on tracked haptic feedback and job quality are disclosed. In one embodiment, a method includes an artificial intelligence agent accessing from entries in a database, quality scores and haptic feedback corresponding to a completed instance of a work task. The method further includes the artificial intelligence agent generating optimized operating parameters based on the haptic feedback data and the quality scores, and transmitting the optimized parameters to a tool used to perform the task.

### CROSS-REFERENCES TO RELATED APPLICATIONS

This application a continuation-in-part of and claims priority to, and the benefit of, U.S. patent application Ser. No. 18/394,298 filed Dec. 22, 2023, titled “SYSTEMS AND METHODS FOR USING A VOCATIONAL MASK WITH A HYPER-ENABLED WORKER,” which claims priority to U.S. Patent Application Ser. No. 63/607,354 filed Dec. 7, 2023, titled “SYSTEMS AND METHODS FOR USING A VOCATIONAL MASK WITH A HYPER-ENABLED WORKER,” the entire disclosure of which are hereby incorporated by reference for all purposes.

This application further claims priority to, and the benefit of U.S. Patent Application Ser. No. 63/640,658 filed Apr. 30, 2024, titled “SYSTEMS AND METHODS FOR USING ARTIFICIAL INTELLIGENCE AND MACHINE LEARNING TO GENERATE OPTIMIZED OPERATING PARAMETERS FOR A WORK TOOL BASED ON TRACK HAPTIC FEEDBACK AND QUALITY OF JOB PERFORMED,” the entire disclosure of which is hereby incorporated by reference for all purposes.

### TECHNICAL FIELD

This disclosure relates to enabling workers to perform vocations. More specifically, this disclosure relates to generating operating optimized operating parameters for performing work tasks associated with the vocations.

### BACKGROUND

People use various tools and/or equipment to perform various vocations. For example, a welder may use a welding mask and/or a welding gun to weld an object. Increasing the quality of welds performed by the welder may be a result of holding the welding gun in a certain position, applying a certain amount of electrical current/voltage, and so on.

### SUMMARY

In one embodiment, a method includes accessing, from a plurality of entries of a database and using an artificial intelligence (AI) agent, quality scores and haptic feedback data, wherein each of the quality scores is indicative of a quality of a completed instance of a work task, and wherein haptic feedback data stored in ones of the plurality of entries comprises one or more parameters. The method further includes generating, using the artificial intelligence agent and based on haptic feedback data and quality scores accessed from the plurality of entries, optimized operating parameters for performing a subsequent instance of a work task, and transmitting the optimized operating parameters to a tool/haptic device used in and during the performing of the subsequent instance of the work task.

The optimized parameters may include parameters such as voltage, current, temperature, and/or a tool position/orientation, among others. One or more vibrations provided to a tool to provide guidance to a user for performing a work task may also one of the optimized parameters. Generation of the optimized parameters may be carried out by the artificial intelligence agent based on the haptic feedback as well as quality scores. In some embodiments, the quality scores may be generated by the artificial intelligence agent, while in other embodiments, the quality scores may be input from another source (e.g., manual input from a user).

The disclosure further contemplates computer-readable medium and a computer system having one or more processors. The computer-readable medium stores instructions that, when executed by, e.g., the one or more processors, execute an artificial intelligence agent to perform the various operations disclosed herein.

Other technical features may be readily apparent to one skilled in the art from the following figures, descriptions, and claims.

### BRIEF DESCRIPTION OF THE DRAWINGS

For a detailed description of example embodiments, reference will now be made to the accompanying drawings in which:

FIG. 1 illustrates a system architecture according to certain embodiments of this disclosure;

FIG. 2 illustrates a component diagram for a vocational mask according to certain embodiments of this disclosure;

FIG. 3 illustrates bidirectional communication between communicatively coupled vocational masks according to certain embodiments of this disclosure;

FIG. 4 illustrates an example of projecting an image onto a user's retina via a virtual retinal display of a vocational mask according to certain embodiments of this disclosure;

FIG. 5 illustrates an example of an image including instructions projected via a virtual retinal display of a vocational mask according to certain embodiments of this disclosure;

FIG. 6 illustrates an example of an image including a warning projected via a virtual retinal display of a vocational mask according to certain embodiments of this disclosure;

FIG. 7 illustrates an example of a method for executing an artificial intelligence agent to determine certain information projected via a vocational mask of a user according to certain embodiments of this disclosure;

FIG. 8 illustrates an example of a method for transmitting instructions for performing a task via bidirectional communication between a vocational mask and a computing device according to certain embodiments of this disclosure;

FIG. 9 illustrates an example of a method for implementing instructions for performing a task using a peripheral haptic device according to certain embodiments of this disclosure;

FIG. 10 illustrates an example computer system according to embodiments of this disclosure;

FIG. 11 illustrates an example of a method for generating optimized operating parameters using an artificial intelligence agent;

FIG. 12 is a block diagram illustrating one embodiment of a system including a database, an artificial intelligence agent, and tools for performing a work task;

FIG. 13 is a block diagram of an example artificial intelligence agent; and

FIG. 14 is a illustrating an embodiment for generating and updating optimized operating parameters using an artificial intelligence agent.

### NOTATION AND NOMENCLATURE

Various terms are used to refer to particular system components. Different entities may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### DETAILED DESCRIPTION

The following discussion is directed to various embodiments of the disclosed subject matter. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

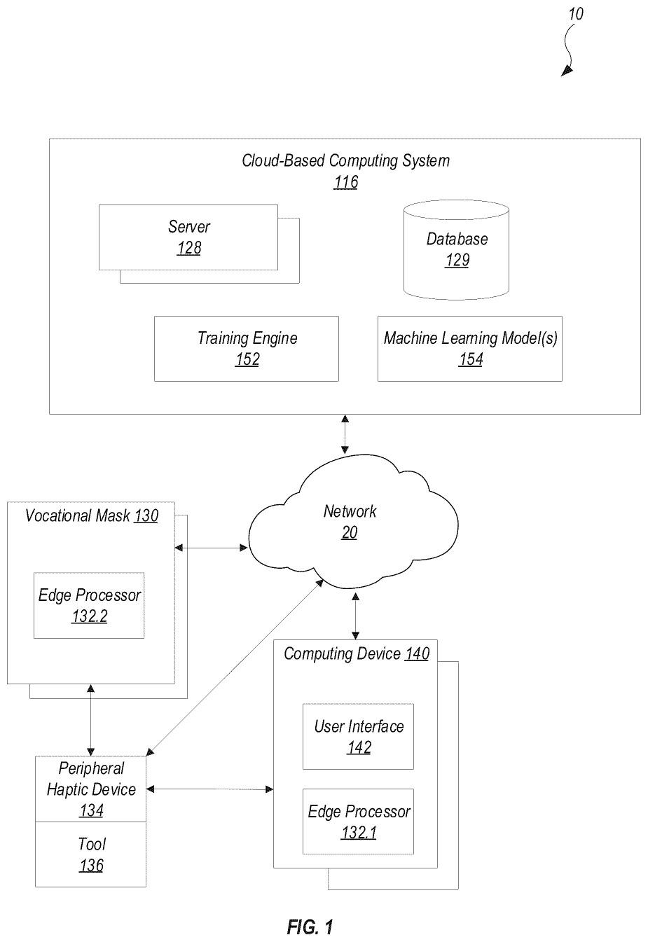

FIGS. 1 through 14 discussed below, and the various embodiments used to describe the principles of this disclosure in this patent document are by way of illustration only and should not be construed in any way to limit the scope of the disclosure.

Some of the disclosed embodiments relate to one or more artificial intelligent enhanced vocational tools for workers to use to perform a job, task, and/or vocation. In some embodiments, the vocational tools may be in the form of a vocational mask that projects work instructions using imagery, animation, video, text, audio, and the like. The vocational tools may be used by workers to enhance the efficiency and proficiency of performing professional and vocational tasks, such as but not limited to supply chain operations, manufacturing and warehousing processes, product inspection, coworker and master-apprentice bidirectional collaboration and communication with or without haptic sensory feedback, other telepresence, and the like.

Some of the disclosed embodiments may be used to collect data, metadata, and multiband video to aid in product acceptance, qualification, and full lifecycle product management. Further, some of the disclosed embodiments may aid a failure reporting, analysis, and corrective action system, a failure mode, effects, and criticality analysis system, other sustainment and support activities and tasks to accommodate worker dislocation and multi-decade lifecycle of some products.

In one embodiment, a vocational mask is disclosed that employs bidirectional communication to include voice and imagery and still and audio video imagery recording with other colleagues over a distance. The vocational mask may provide virtual images of objects to a person wearing the vocational mask via a display (e.g., virtual retinal display). The vocational mask may enable bidirectional communications with collaborators and/or students (e.g., in a master-apprentice relationship). Further, the vocational mask may enable bidirectional audio, visual, and haptic communication to provide a master-apprentice relationship. A master-apprentice relationship may include virtually any teacher-student relationship or other type of relationship in which a wearer of the vocational mask carries out a task while receiving instructions or directions from another user via another computing device that is operatively coupled (e.g., via a network) to the vocational mask. Examples include, but are not limited to, an apprentice carrying out a task within a skilled trade under instruction of a master, a resident carrying out a medical procedure under instruction of a licensed doctor, and so on.

The disclosure further contemplates the wearer of the vocational mask being a collaborator with another user via another operatively coupled computing device (which may be another vocational mask or any other suitable computing device). Accordingly, two or more users may collaborate on performing a task or a learning exercise during a virtual reality session that is shared with or by a vocational mask.

Furthermore, the disclosure contemplates the sharing and switching of contexts between users in a shared virtual reality session, including at least one user wearing a vocational mask. For example a user wearing a first vocational mask may share a virtual reality session with another user wearing a second vocational mask, with the first user operating in a first context and the second user operating in a second context. However, these contexts may be switched during the virtual reality session such that, in this example, the first and second users exchange contexts. For example, in a master-apprentice relationship, a second user in the master role may send haptic data to a first user in an apprentice role to provide haptic instruction (e.g., vibration of a peripheral haptic device associated with a tool) on manipulating a tool. After a switch of contexts, the first user may send haptic data to the second user to enable the latter to use haptic feedback to monitor the manipulation of the tool by the first user.

In another example, two or more users performing a complex repair of a system may each, at times during the repair, require control of the system. A first user, wearing a vocational mask, may be on-site, and in a first context, may have control of the system under repair to enable certain steps to be carried out while the second user is in an observational context. At some point during the repair, a context switch may be performed in which the first user transfers control of the system to be carried out remotely by the second user, with the first user assuming an observational role.

The vocational mask may include multiple electromagnetic spectrum and acoustic sensors/imagers. The vocational mask may also provide multiband audio and video sensed imagery to a wearer of the vocational mask.

The vocational mask may be configured to provide display capabilities to project images onto one or more irises of the wearer to display alphanumeric data and graphic/animated work instructions, for example. The vocational mask may also include one or more speakers to emit audio related to work instructions, such as those provided by a master trained user, supervisor, collaborator, teacher, etc.

The vocational mask may include an edge-based processor that executes an artificial intelligence agent. The artificial intelligence agent may be implemented in computer instructions stored on one or more memory devices and executed by one or more processing devices (e.g., edge processor or processors). The artificial intelligence agent may be trained to perform one or more functions, such as but not limited to (i) perception-based object and feature identification, (ii) cognition-based scenery understanding, to identify material and assembly defects versus acceptable features, and (iii) decision making to aid the wearer and to provide relevant advice and instruction in real-time or near real-time to the wearer of the vocational mask. The data that is collected may be used for inspection and future analyses of product quality, product design, and the like. Further, the collected data may be stored for instructional analyses and providing lessons, mentoring, collaboration, and the like.

The vocational mask may include one or more components (e.g., processing device, memory device, display, etc.), interfaces, and/or sensors configured to provide sensing capabilities to understand hand motions and use of a virtual user interface (e.g., keyboards) and other haptic instructions. The vocational mask may include a haptic interface to allow physical bidirectional haptic sensing and stimulation via the bidirectional communications to other users and/or collaborators using a peripheral haptic device (e.g., a welding gun).

In some embodiments, the vocational mask may be in the form of binocular goggles, monocular goggle, finishing process glasses (e.g., grind, chamfer, debur, sand polish, coat, etc.), or the like. The vocational mask may be attached to a welding helmet. The vocational mask may include an optical bench that aligns a virtual retinal display to one or more eyes of a user. Certain types of data (e.g., video and image) may be projected from the virtual retinal display into the retinal of a user. The vocational mask may include a liquid crystal display welding helmet, a welding camera, an augmented reality/virtual reality headset, etc.

The vocational mask may augment projections by providing augmented reality cues and information to assist a worker (e.g., welder) with contextual information, which may include setup, quality control, procedures, training, and the like. Further, the vocational mask may provide a continuum of visibility from visible spectrum (arc off) through high-intensity/ultraviolet (arc on). Further, some embodiments include remote feedback and recording of images and bidirectional communications to a trainer, supervisor, mentor, master user, teacher, collaborator, etc. who can provide visual, auditory, and/or haptic feedback to the wearer of the vocational mask in real-time or near real-time.

In some embodiments, the vocational mask may be integrated with a welding helmet. In some embodiments, the vocational mask may be (or include) a set of augmented reality/virtual reality goggles worn under a welding helmet (e.g., with external devices, sensors, cameras, etc. appended for image/data gathering). In some embodiments, the vocational mask may be a set of binocular welding goggles or a monocular welding goggle to be worn under or in lieu of a welding helmet (e.g., with external devices, sensors, cameras, etc. appended to the goggles for image/data gathering). In some embodiments, the vocational mask may include a mid-band or long wave context camera displayed to the user and monitor.

In some embodiments, information may be superpositioned or superimposed onto a display without the user (e.g., worker, student, etc.) wearing a vocational mask. The information may include work instructions in the form of text, images, alphanumeric characters, video, etc. The vocational mask may function across both visible light (arc off) and high intensity ultraviolet light (arc on) conditions. The vocational mask may natively or in conjunction with other personal protective equipment provide protection against welding flash. The vocational mask may enable real-time or near real-time two-way communication with a remote instructor or supervisor. The vocational mask may provide one or more video, audio, and data feeds to a remote instructor or supervisor. The vocational mask and/or other components in a system may enable recording of all data and communications. The system may provide a mechanism for replaying the data and communications, via a media player, for training purposes, quality control purposes, inspection purposes, and the like. The vocational mask and/or other components in a system may provide a mechanism for visual feedback from a remote instructor or supervisor. The vocational mask and/or other components in a system may provide a bidirectional mechanism for haptic feedback from a remote instructor or supervisor.

Further, the system may include an artificial intelligence simulation generator that generates task simulations to be transmitted to and presented via the vocational mask. The simulation of a task may be transmitted as virtual reality data to the vocational mask which includes a virtual reality headset and/or display to playback the virtual reality data. The virtual reality data may be configured based on parameters of a physical space in which the vocational mask is located, based on parameters of an object to be worked on, based on parameters of a tool to be used, and the like.

Some embodiments of the system may also include an artificial intelligence agent that is implemented in instructions stored on one or more memory devices and executable on one or more processing devices of the vocational mask. The artificial intelligence agent is trained such that, when executed, it may monitor one or more aspects of the virtual reality session and may additionally provide directions for performing a task to a user wearing the vocational mask. The artificial intelligence agent may also monitor one or more properties of a task performed by a user wearing the vocational mask. For example, if the task is welding, the artificial intelligence agent may monitor one or more properties of a weld formed by the first user. Based on the one or more monitored properties, the artificial intelligence agent may adjust the directions provided to the user for carrying out the task. In various embodiments, the artificial intelligence agent may monitor a number of different types of tasks in addition to the example of welding given here. Other tasks monitored by the artificial intelligence agent may include (but are not limited to) brazing, soldering, and other types of mechanical and/or industrial processes that may be carried out by a user, medical procedures to be carried out by a resident under instruction of a doctor (as well as procedures carried out by one doctor with the assistance of another), repair operations carried out by a technician with the assistance of an engineer or other technician, and so on.

Turning now to the figures, FIG. 1 depicts a system architecture 10 according to some embodiments. The system architecture 10 may include one or more computing devices 140, one or more vocational masks 130, one or more peripheral haptic devices 134, and/or one or more tools 136 communicatively coupled to a cloud-based computing system 116. Each of the computing devices 140, vocational masks 130, peripheral haptic devices 134, tools 136, and components included in the cloud-based computing system 116 may include one or more processing devices, memory devices, and/or network interface cards. The network interface cards may enable communication via a wireless protocol for transmitting data over short distances, such as Bluetooth, ZigBee, NFC, etc. Additionally, the network interface cards may enable communicating data over long distances, and in one example, the computing devices 140, the vocational masks 130, the peripheral haptic devices 134, the tools 136, and the cloud-based computing system 116 may communicate with a network 20. Network 20 may be a public network (e.g., connected to the Internet via wired (Ethernet) or wireless (WiFi)), a private network (e.g., a local area network (LAN) or wide area network (WAN)), or a combination thereof. Network 20 may also include a node or nodes on the Internet of Things (IoT). The network 20 may be a cellular network.

The computing devices 140 may be any suitable computing device, such as a laptop, tablet, smartphone, smartwatch, ear buds, server, or computer. In some embodiments, the computing device 140 may be a vocational mask. The computing devices 140 may include a display capable of presenting a user interface 142 of an application. In some embodiments, the display may be a laptop display, smartphone display, computer display, tablet display, a virtual retinal display, etc. The application may be implemented in computer instructions stored on the one or more memory devices of the computing devices 140 and executable by the one or more processing devices of the computing device 140. The application may present various screens to a user. For example, the user interface 142 may present a screen that plays video received from the vocational mask 130. The video may present real-time or near real-time footage of what the vocational mask 130 is viewing, and in some instances, that may include a user's hands holding the tool 136 to perform a task (e.g., weld, sand, polish, chamfer, debur, paint, play a video game, etc.). Additional screens may be presented via the user interface 142.

In some embodiments, the application (e.g., website) executes within another application (e.g., web browser). The computing device 140 may also include instructions stored on the one or more memory devices that, when executed by the one or more processing devices of the computing devices 140 perform operations of any of the methods described herein.

In some embodiments, the computing devices 140 may include an edge processor 132.1 that performs one or more operations of any of the methods described herein. The edge processor 132.1 may execute an artificial intelligence agent to perform various operations described herein. The artificial intelligence agent may include one or more machine learning models that are trained via the cloud-based computing system 116 as described herein. The edge processor 132.1 may represent one or more general-purpose processing devices such as a microprocessor, central processing unit, or the like. More particularly, the edge processor 132.1 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The edge processor 132.1 may also be one or more special-purpose processing devices such as an application specific integrated circuit (ASIC), a field programmable gate array (FPGA), a digital signal processor (DSP), network processor, or the like.

In some embodiments, the vocational mask 130 may be attached to or integrated with a welding helmet, binocular goggles, a monocular goggle, glasses, a hat, a helmet, a virtual reality headset, a headset, a facemask, or the like. The vocational mask 130 may include various components as described herein, such as an edge processor 132.2. In some embodiments, the edge processor 132.2 may be located separately from the vocational mask 130 and may be included in another computing device, such as a server, laptop, desktop, tablet, smartphone, etc. The edge processor 132.2 may represent one or more general-purpose processing devices such as a microprocessor, central processing unit, or the like. More particularly, the edge processor 132.2 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The edge processor 132.2 may also be one or more special-purpose processing devices such as an application specific integrated circuit (ASIC), a field programmable gate array (FPGA), a digital signal processor (DSP), network processor, or the like.

The edge processor 132.2 may perform one or more operations of any of the methods described herein. The edge processor 132.2 may execute an artificial intelligence agent to perform various operations described herein. The artificial intelligence agent may include one or more machine learning models that are trained via the cloud-based computing system 116 as described herein. For example, the cloud-based computing system 116 may train one or more machine learning models 154 via a training engine 152, and may transmit the parameters used to train the machine learning model to the edge processor 132.2 such that the edge processor 132.2 can implement the parameters in the machine learning models executing locally on the vocational mask 130 or computing device 140. The machine learning models may be trained to monitor various aspects of a virtual reality session between, e.g., an apprentice and a master, and may further be trained to monitor properties of tasks carried out by the apprentice (e.g., a weld, a solder joint, etc.). Based on this monitoring, an artificial intelligence agent using these machine learning models may adjust instructions/directions provided to the apprentice.

The edge processor 132.2 may include a data concentrator that collects data from multiple vocational masks 130 and transmits the data to the cloud-based computing system 116. The data concentrator may map information to reduce bandwidth transmission costs of transmitting data. In some embodiments, a network connection may not be needed for the edge processor 132.2 to collect data from vocational masks and to perform various functions using the trained machine learning models 154.

The vocational mask 130 may also include a network interface card that enables bidirectional communication with any other computing device 140, such as other vocational masks 130, smartphones, laptops, desktops, servers, wearable devices, tablets, etc. The vocational mask 130 may also be communicatively coupled to the cloud-based computing system 116 and may transmit and receive information and/or data to and from the cloud-based computing system 116. The vocational mask 130 may include various sensors, such as position sensors, acoustic sensors, haptic sensors, microphones, temperature sensors, accelerometers, and the like. The vocational mask 130 may include various cameras configured to capture audio and video. The vocational mask 130 may include a speaker to emit audio. The vocational mask 130 may include a haptic interface configured to transmit and receive haptic data to and from the peripheral haptic device 134. The haptic interface may be communicatively coupled to a processing device (e.g., edge processor 132.2) of the vocational mask 130.

In some embodiments, the peripheral haptic device 134 may be attached to or integrated with the tool 136. In some embodiments, the peripheral haptic device 134 may be separate from the tool 136. The peripheral haptic device 134 may include one or more haptic sensors that provide force, vibration, touch, and/or motion sensations to the user, among other things. The peripheral haptic device 134 may be used to enable a person remote from a user of the peripheral haptic device 134 to provide haptic instructions to perform a task (e.g., weld, shine, polish, paint, control a video game controller, grind, chamfer, debur, etc.). The peripheral haptic device 134 may include one or more processing devices, memory devices, network interface cards, haptic interfaces, etc. In some embodiments, the peripheral haptic device 134 may be communicatively coupled to the vocational mask 130, the computing device 140, and/or the cloud-based computing system 116.

The tool 136 may be any suitable tool, such as a welding gun, a video game controller, a paint brush, a pen, a utensil, a grinder, a sander, a polisher, a gardening tool, a yard tool, a glove, medical tools, a brazing torch, a soldering iron, a mechanical tool such as a wrench or pliers, or the like. The tool 136 may be handheld such that the peripheral haptic device 134 is enabled to provide haptic instructions for performing a task to the user holding the tool 136. In some embodiments, the tool 136 may be wearable by the user. The tool 136 may be used to perform a task. In some embodiments, the tool 136 may be located in a physical proximity to the user in a physical space.

In some embodiments, the cloud-based computing system 116 may include one or more servers 128 that form a distributed computing architecture. The servers 128 may be a rackmount server, a router computer, a personal computer, a portable digital assistant, a mobile phone, a laptop computer, a tablet computer, a camera, a video camera, a netbook, a desktop computer, a media center, any other device capable of functioning as a server, or any combination of the above. Each of the servers 128 may include one or more processing devices, memory devices, data storage, and/or network interface cards. The servers 128 may be in communication with one another via any suitable communication protocol. The servers 128 may execute an artificial intelligence (AI) engine and/or an AI agent that uses one or more machine learning models 154 to perform at least one of the embodiments disclosed herein. The cloud-based computing system 116 may also include a database 129 that stores data, knowledge, and data structures used to perform various embodiments. For example, the database 129 may store multimedia data of users performing tasks using tools, communications between vocational masks 130 and/or computing devices 140, virtual reality simulations, augmented reality information, recommendations, instructions, and the like. The database 129 may also store user profiles including characteristics particular to each user. In some embodiments, the database 129 may be hosted on one or more of the servers 128.

In some embodiments the cloud-based computing system 116 may include a training engine 152 capable of generating the one or more machine learning models 154. The machine learning models 154 may be trained to identify perception-based objects and features using training data that includes labeled inputs of images including certain objects and features mapped to labeled outputs of identities or characterizations of those objects and features. The machine learning models 154 may be trained determine cognition-based scenery to identify one or more material defects, one or more assembly defects, one or more acceptable features, or some combination thereof using training data that includes labeled input of scenery images of objects including material defects, assembly defects, and/or acceptable features mapped to labeled outputs that characterize and/or identify the material defects, assembly defects, and/or acceptable features. The machine learning models 154 may be trained to determine one or more recommendations, instructions, or both using training data including labeled input of images (e.g., objects, products, tools, actions, etc.) and tasks to be performed (e.g., weld, grind, chamfer, debur, sand, polish, coat, etc.) mapped to labeled outputs including recommendations, instructions, or both.

The one or more machine learning models 154 may be generated by the training engine 152 and may be implemented in computer instructions executable by one or more processing devices of the training engine 152 and/or the servers 128. To generate the one or more machine learning models 154, the training engine 152 may train the one or more machine learning models 154. The one or more machine learning models 154 may also be executed by the edge processor 132 (132.1, 132.2). The parameters used to train the one or more machine learning models 154 by the training engine 152 at the cloud-based computing system 116 may be transmitted to the edge processor 132 (132.1, 132.2) to be implemented locally at the vocational mask 130 and/or the computing device 140.

The training engine 152 may be a rackmount server, a router computer, a personal computer, a portable digital assistant, a smartphone, a laptop computer, a tablet computer, a netbook, a desktop computer, an Internet of Things (IoT) device, any other desired computing device, or any combination of the above. The training engine 152 may be cloud-based, be a real-time software platform, include privacy software or protocols, and/or include security software or protocols. To generate the one or more machine learning models 154, the training engine 152 may train the one or more machine learning models 154.

The one or more machine learning models 154 may refer to model artifacts created by the training engine 152 using training data that includes training inputs and corresponding target outputs. The training engine 152 may find patterns in the training data wherein such patterns map the training input to the target output and generate the machine learning models 154 that capture these patterns. Although depicted separately from the server 128, in some embodiments, the training engine 152 may reside on server 128. Further, in some embodiments, the database 129, and/or the training engine 152 may reside on the computing devices 140.

As described in more detail below, the one or more machine learning models 154 may comprise, e.g., a single level of linear or non-linear operations (e.g., a support vector machine [SVM]) or the machine learning models 154 may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each neuron may transmit its output signal to the input of the remaining neurons, as well as to itself). For example, the machine learning model may include numerous layers and/or hidden layers that perform calculations (e.g., dot products) using various neurons.

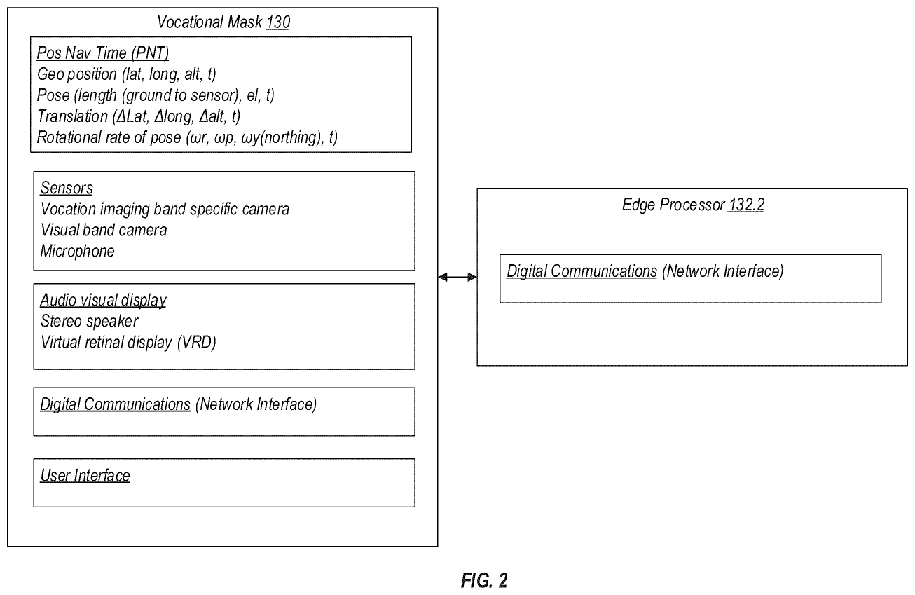

FIG. 2 illustrates a component diagram for a vocational mask 130 according to certain embodiments of this disclosure. The edge processor 132.2 is also depicted. In some embodiments, the edge processor 132.2 may be included in a computing device separate from the vocational mask 130, and in some embodiments, the edge processor 132.2 may be included in the vocational mask 130.

The vocational mask 130 may include various position, navigation, and time (PNT) components, sensors, and/or devices that enable determining the geographical positon (latitude, longitude, altitude, time), pose (length (ground to sensor), elevation, time), translation (delta in latitude, delta in longitude, delta in altitude, time), the rotational rate of pose (ω_r,ω_p,ω_y (northing),t), and the like, where ω_r represents the roll rate, which is the angular velocity about the longitudinal axis of the vocational mask 130, ω_p represents the pitch rate, which is the angular velocity about the lateral axis of the vocational mask 130, ω_y (northing) represents the yaw rate, which is the angular velocity about the vertical axis of the vocational mask 130, referenced with respect to the northing direction, and t represents the time at which these rotational rates are measured. In some embodiments, the vocational mask 130 may include one or more sensors, such as vocation imaging band specific cameras, visual band cameras, microphones, and the like.

In some embodiments, the vocational mask 130 may include an audio visual display, such as a stereo speaker, a virtual retinal display, a liquid crystal display, a virtual reality headset, and the like. A virtual retinal display may be a retinal scan display or retinal projector that draws a raster display directly onto the retina of the eye. In some embodiments, the virtual retinal display may include drive electronics that transmit data to a photon generator and/or intensity modulator. These components may process the data (e.g., video, audio, haptic, etc.) and transmit the processed data to a beam scanning component that further transmits data to an optical projector that projects an image and/or video to a retina of a user.

In some embodiments, the vocational mask 130 may include a network interface card that enables bidirectional communication (digital communication) with other vocational masks and/or computing device 140.

In some embodiments, the vocational mask 130 may provide a user interface to the user via the display described herein.

In some embodiments, the edge processor 132.2 may include a network interface card that enables digital communication with the vocational mask 130, the computing device 140, the cloud-based computing system 116, or the like.

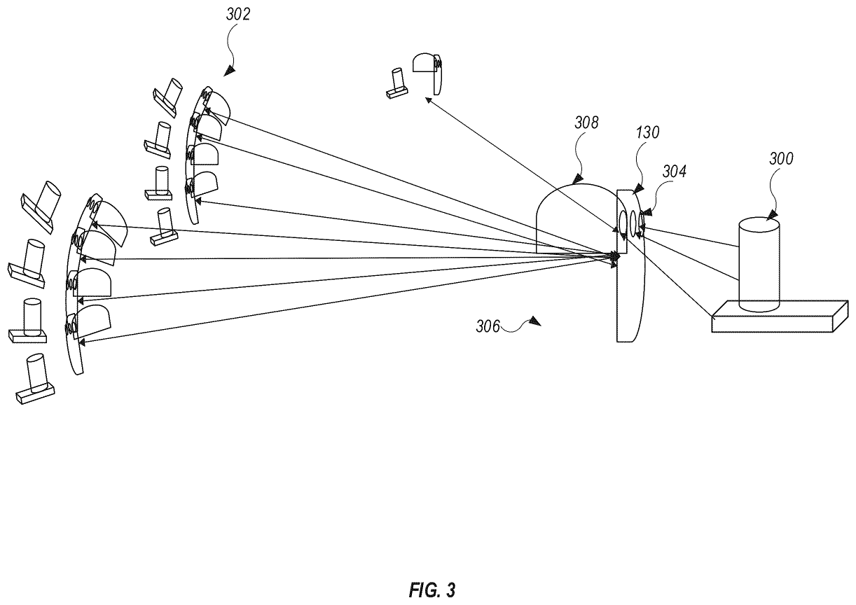

FIG. 3 illustrates bidirectional communication between communicatively coupled vocational masks 130 and 302 according to certain embodiments of this disclosure. As depicted, a user 306 is wearing a vocational mask 130. In the depicted example, the vocational mask 130 is attached to or integrated with a welding helmet 308. The user is viewing an object 300 (e.g., a workpiece). The vocational mask 130 may include multiple electromagnetic spectrum and/or acoustic sensors/imagers 304 to enable obtaining audio, video, acoustic, etc. data while observing the object 300 and/or performing a task (e.g., welding).

Further, as depicted, the vocational mask 130 may be communicatively coupled to one or more other vocational masks 302 worn by other users and may communicate data in real-time or near real-time such that bidirectional audio visual and haptic communications fosters a master-apprentice relationship, a teacher-student relationship, a relationship between collaborators, or other type of relationship. In some embodiments, the bidirectional communication enabled by the vocational masks 130 may enable collaboration between a teacher or collaborator and students. Each of the users wearing the vocational mask 130 may be enabled to visualize the object 300 that the user is viewing in real-time or near real-time.

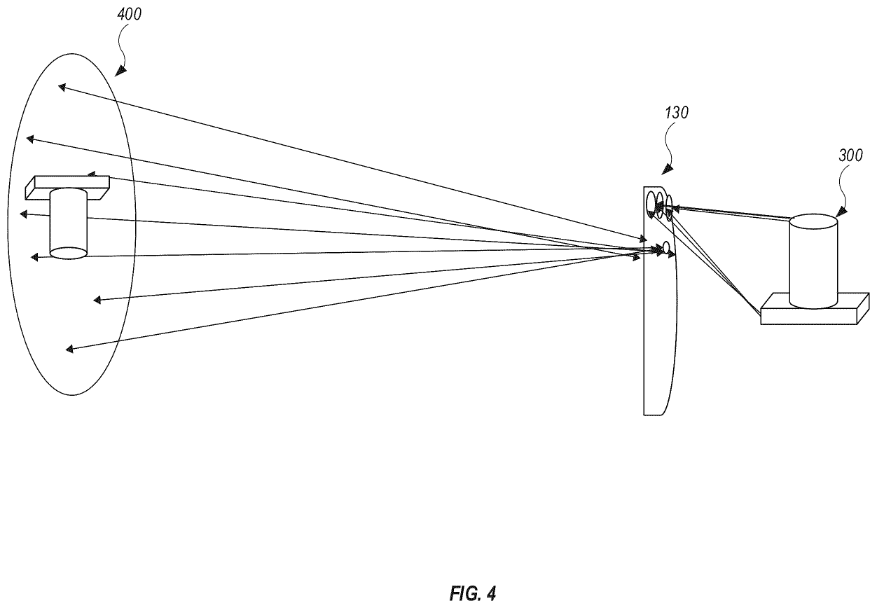

FIG. 4 illustrates an example of projecting an image onto a user's retina 400 via a virtual retinal display of a vocational mask 130 according to certain embodiments of this disclosure. As depicted, the imagers and/or cameras of the vocational mask 130 receive data pertaining to the object and the vocational mask 130 processes the data and projects an image representing the object 300 using a virtual retinal display onto the user's retina 400. The bidirectional communication with other users (e.g., students, master user, collaborator, teacher, supervisor, etc.) may enable projecting the image onto their retinas if they are wearing a vocational mask, as well. In some embodiments, the image may be displayed via a computing device 140 if the other users are not wearing vocational masks.

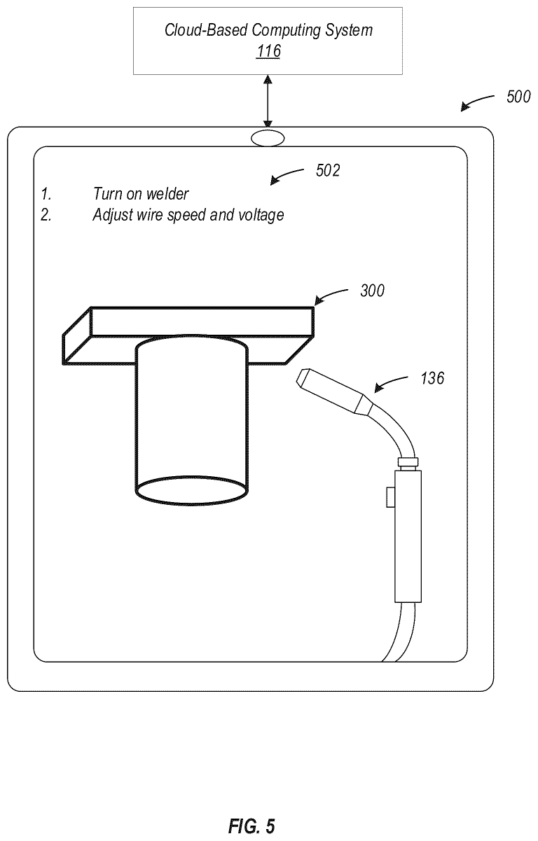

FIG. 5 illustrates an example of an image including instructions projected via a virtual retinal display of a vocational mask 130 according to certain embodiments of this disclosure. The example user interface 500 depicts actual things the user is looking at, such as a tool 136 and an object 300 (e.g., a workpiece), through the vocational mask 130. Further, the user interface depicts instructions 502 pertaining to performing a task. The instructions 502 may be generated by one or more machine learning models 154 of the AI agent, or may be provided via a computing device 140 and/or other vocational mask being used by another user (e.g., master user, collaborator, teacher, supervisor, etc.). In the depicted example, the instructions 502 instruct the user to “1. Turn on welder; 2. Adjust wire speed and voltage”. The instructions 502 may be projected on the user's retina via the virtual retinal display and/or presented on a display of the vocational mask 130.

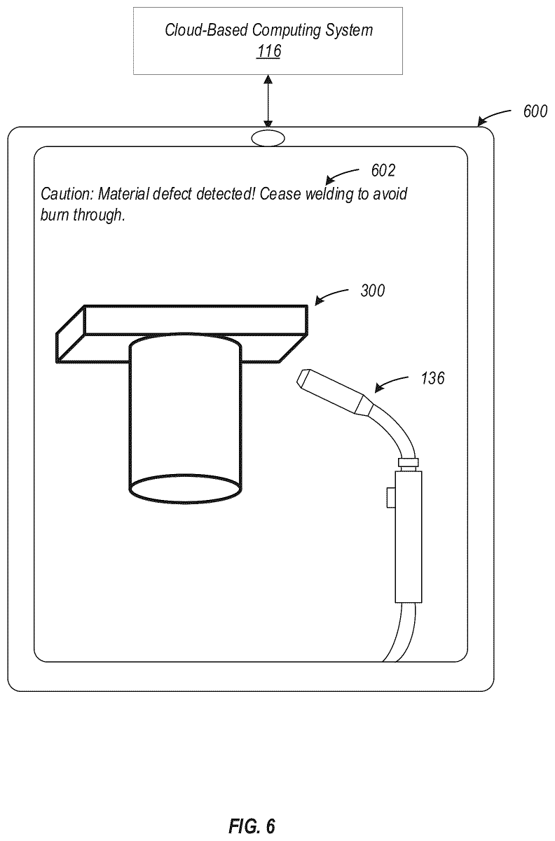

FIG. 6 illustrates an example of an image including a warning projected via a virtual retinal display of a vocational mask according to certain embodiments of this disclosure. The example user interface 600 depicts actual things the user is looking at, such as a tool 136 and an object 300, through the vocational mask 130. Further, the user interface depicts a warning 602 pertaining to performing a task. The warning 602 may be generated by one or more machine learning models 154 of the AI agent, or may be provided via a computing device 140 and/or other vocational mask being used by another user (e.g., master user, collaborator, teacher, supervisor, etc.). In the depicted example, the warning 602 indicates “Caution: Material defect detected! Cease welding to avoid burn through”. The warning 602 may be projected on the user's retina via the virtual retinal display and/or presented on a display of the vocational mask 130.

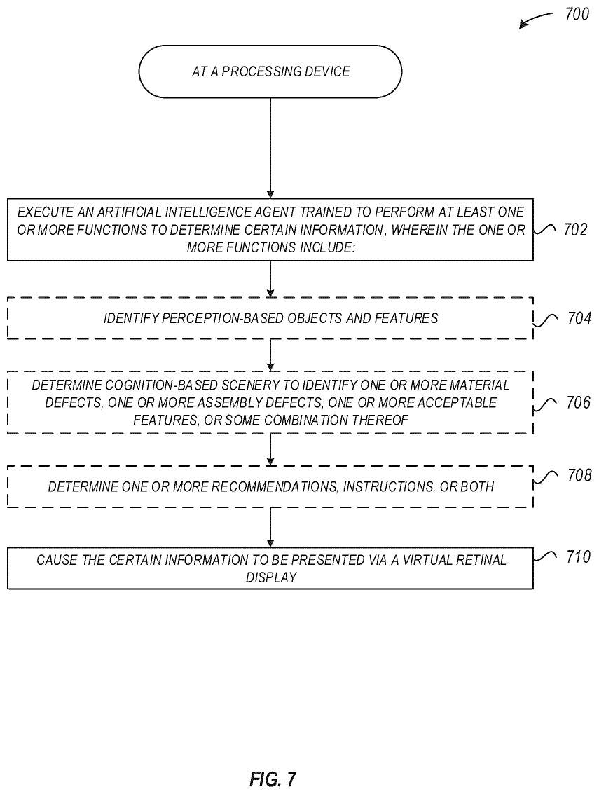

FIG. 7 illustrates an example of a method 700 for executing an artificial intelligence agent to determine certain information projected via a vocational mask of a user according to certain embodiments of this disclosure. The method 700 may be performed by processing logic that may include hardware (circuitry, dedicated logic, etc.), software, or a combination of both. The method 700 and/or each of their individual functions, subroutines, or operations may be performed by one or more processing devices of a computing device (e.g., any component (server 128, training engine 152, machine learning models 154, etc.) of cloud-based computing system 116, vocational mask 130, edge processor 132 (132.1, 132.2), peripheral haptic device 134, tool 136, and/or computing device 140 of FIG. 1) implementing the method 700. The method 700 may be implemented as computer instructions stored on a memory device and executable by the one or more processors. In certain implementations, the method 700 may be performed by a single processing thread. Alternatively, the method 700 may be performed by two or more processing threads, each thread implementing one or more individual functions, routines, subroutines, or operations of the methods.

For simplicity of explanation, the method 700 is depicted and described as a series of operations. However, operations in accordance with this disclosure can occur in various orders or concurrently, and with other operations not presented and described herein. For example, the operations depicted in the method 700 may occur in combination with any other operation of any other method disclosed herein. Furthermore, not all illustrated operations may be required to implement the method 700 in accordance with the disclosed subject matter. In addition, those skilled in the art will understand and appreciate that the method 700 could alternatively be represented as a series of interrelated states via a state diagram or events.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

In some embodiments, a system may include the vocational mask 130, which may include one or more virtual retinal displays, memory devices, processing devices, and other components as described herein. The processing devices may be communicatively coupled to the memory devices that store computer instructions, and the processing devices may execute the computer instructions to perform one or more of the steps of the method 700. In some embodiments, the system may include a welding helmet and the vocational mask may be coupled to the welding helmet. In some embodiments, the vocational mask may be configured to operate across both visible light and high intensity ultraviolet light conditions. In some embodiments, the vocational mask may provide protection against welding flash. In some embodiments, the vocational mask may be integrated with goggles. In some embodiments, the vocational mask may be integrated with binoculars or a monocular.

At block 702, the processing device may execute an artificial intelligence agent trained to perform at least one or more functions to determine certain information. The functions may include (i) identifying perception-based objects and features, (ii) determining cognition-based scenery to identify one or more material defects, one or more assembly defects, one or more acceptable features, or some combination thereof, and (iii) determining one or more recommendations, instructions, or both.

The artificial intelligence agent may include one or more machine learning models 154 trained to perform the functions. For example, one or more machine learning models 154 may be trained to (i) identify perception-based objects and features using training data that includes labeled inputs of images including certain objects and features mapped to labeled outputs of identities or characterizations of those objects and features. The machine learning models may be trained to analyze aspects of the objects and features to compare the aspects to known aspects associated with known objects and features, and the machine learning models may perceive the identity of the analyzed objects and features.

At block 706, the one or more machine learning models 154 may be trained to (ii) determine cognition-based scenery to identify one or more material defects, one or more assembly defects, one or more acceptable features, or some combination thereof using training data that includes labeled input of scenery images of objects including material defects, assembly defects, and/or acceptable features mapped to labeled outputs that characterize and/or identify the material defects, assembly defects, and/or acceptable features. For example, one scenery image may include a portion of a submarine that includes parts that are welded together, and the machine learning models may be trained to cognitively analyze the scenery image to identify one or more portions of the scenery image that includes a welded part with a material welding defect, a part assembly defect, and/or acceptable welded feature.

At block 708, the one or more machine learning models 154 may be trained to (iii) determine one or more recommendations, instructions, or both using training data including labeled input of images (e.g., objects, products, tools, actions, etc.) and tasks to be performed (e.g., weld, grind, chamfer, debur, sand, polish, coat, etc.) mapped to labeled outputs including recommendations, instructions, or both. The processing device may provide (e.g., via the virtual retinal display, a speaker, etc.) images, video, and/or audio that points out the defects and provides instructions, drawings, and/or information pertaining to how to fix the defects.

In addition, the output from performing one of the functions (i), (ii), and/or (iii) may be used as input to the other functions to enable the machine learning models 154 to generate a combined output. For example, the machine learning models 154 may identify a defect (a gouge) and provide welding instructions on how to fix the defect by filling the gouge properly via the vocational mask 130. Further, in some instances, the machine learning models 154 may identify several potential actions that the user can perform to complete the task and may aid the user's decision making by providing the actions in a ranked order of most preferred action to least preferred action or a ranked order of the action with the highest probability of success to the action with the lowest probability of success. In some embodiments, the machine learning models 154 may identify an acceptable feature (e.g., properly welded parts) and may output a recommendation to do nothing.

The artificial intelligence agent may further monitor one or more aspects of a virtual reality session. Based on the monitoring, the artificial intelligence agent may generate and provide, in real time, direction for performing a given task, during the virtual reality session, by a first user wearing the vocational mask. Alternatively, the artificial intelligence agent may generate suggested instructions by a master/teacher sharing the virtual reality session with an apprentice/student.

Embodiments are further contemplated in which the artificial intelligence agent may generate and provide, to various users of the shared virtual reality session, information in furtherance of completing a task where the various users are collaborators. In such collaborative environments, the various users of the shared virtual reality session may have different contexts, with such contexts being switchable among users. For example a context may be control of a machine that can be carried out locally or remotely, and these contexts may be exchanged among the different users in the shared virtual reality session. The artificial intelligence agent may adjust which user receives particular information based on such context switches.

At block 710, the processing device may cause the certain information to be presented via the virtual retinal display. In some embodiments, the virtual retinal display may project an image onto at least one iris of the user to display alphanumeric data, graphic instructions, animated instructions, video instructions, or some combination thereof. In some embodiments, the vocational mask may include a stereo speaker to emit audio pertaining the information. In some embodiments, the processing device may superposition the certain information on a display (e.g., virtual retinal display).

In some embodiments, the vocational mask may include a network interface configured to enable bidirectional communication with a second network interface of a second vocational mask. The bidirectional communication may enable transmission of real-time or near real-time audio and video data, recorded audio and video data, or some combination thereof. “Real-time” may refer to less than 2 seconds and “near real-time” may refer to between 2 and 20 seconds.

In some embodiments, in addition to the vocational mask, a system may include a peripheral haptic device. The vocational mask may include a haptic interface, and the haptic interface may be configured to perform bidirectional haptic sensing and stimulation using the peripheral haptic device and the bidirectional communication. The stimulation may include precise mimicking, vibration, and the like. For example, the stimulation may include performing mimicked gestures via the peripheral haptic device. In other words, a master user may be using a peripheral haptic device to perform a task and the gestures performed by the master user using the peripheral haptic device may be mimicked by the peripheral haptic device being used by an apprentice user. In such a way, the master user may train and/or guide the apprentice user how to properly perform a task (e.g., weld) using the peripheral haptic devices.

The haptic interface may be communicatively coupled to the processing device. The haptic interface may be configured to sense, from the peripheral haptic device, hand motions, texture, temperature, vibration, slipperiness, friction, wetness, pulsation, stiction, friction, and the like. For example, the haptic interface may detect keystrokes when a user uses a virtual keyboard presented via the vocational mask using a display (e.g., virtual retinal display).

Further, the bidirectional communication provided by the vocational mask(s) and/or computing devices may enable a master user of a vocational mask and/or computing device to view and/or listen to the real-time or near real-time audio and video data, recorded audio and video data, or some combination thereof, and to provide instructions to the user via the vocational mask being worn by the user. In some embodiments, the bidirectional communication provided by the vocational mask(s) and/or computing devices may enable the user of a vocational mask and/or computing device to provide instructions to a set of students and/or apprentices via multiple vocational masks being worn by the students and/or apprentices. This technique may be beneficial for a teacher, collaborator, master user, and/or supervisor that is training the set of students.

In some embodiments, the user wearing a vocational mask may communicate with one or more users who are not wearing a vocational mask. For example, a teacher and/or collaborator may be using a computing device (e.g., smartphone) to see what a student is viewing and hear what the student is hearing using the bidirectional communication provided by the vocational mask worn by the student. The bidirectional communication provided by the vocational mask may enable a teacher or collaborator to receive, using a computing device, audio data, video data, haptic data, or some combination thereof, from the vocational mask being used by the user.

Additionally, the teacher and/or collaborator may receive haptic data, via the computing device, from the vocational mask worn by the student. The teacher and/or collaborator may transmit instructions (e.g., audio, video, haptic, etc.), via the computing device, to the vocational mask to guide and/or teach the student how to perform the task (e.g., weld) in real-time or near real-time.

In another example, the bidirectional communication may enable a user wearing a vocational mask to provide instructions to a set of students via a set of computing devices (e.g., smartphones). In this example, the user may be a teacher or collaborator and may be teaching a class or lesson on how to perform a task (e.g., weld) while wearing the vocational mask.

In some embodiments, the vocational mask may include one or more sensors to provide information related to geographical position, pose of the user, rotational rate of the user, or some combination thereof. In some embodiments, a position sensor may be used to determine a location of the vocational mask, an object, a peripheral haptic device, a tool, etc. in a physical space. The position sensor may determine an absolute position in relation to an established reference point. In some embodiments, the processing device may perform physical registration of the vocational mask, an object being worked on, a peripheral haptic device, a tool (e.g., welding gun, sander, grinder, etc.), etc. to map out the device in an environment (e.g., warehouse, room, underwater, etc.) in which the vocational mask, the object, the peripheral haptic device, etc. is located.

In some embodiments, the vocational mask may include one or more sensors including vocation imaging band specific cameras, visual band cameras, stereo microphones, acoustic sensors, or some combination thereof. The acoustic sensors may sense welding clues based on audio signatures associated with certain defects or issues, such as burn through. Machine learning models 154 may be trained using inputs of labeled audio signatures, labeled images, and/or labeled videos mapped to labeled outputs of defects. The artificial intelligence agent may process received sensor data, such as images, audio, video, haptics, etc., identify an issue (e.g., defect), and provide a recommendation (e.g., stop welding due to detected potential burn through) via the vocational mask.

In some embodiments, the vocational mask may include an optical bench that aligns the virtual retinal display to one or more eyes of the user.

In some embodiments, the processing device is configured to record the certain information, communications with other devices (e.g., vocational masks, computing devices), or both. The processing device may store certain information and/or communications as data in the memory device communicatively coupled to the processing device, and/or the processing device may transmit the certain information and/or communications as data feeds to the cloud-based computing system 116 for storage.

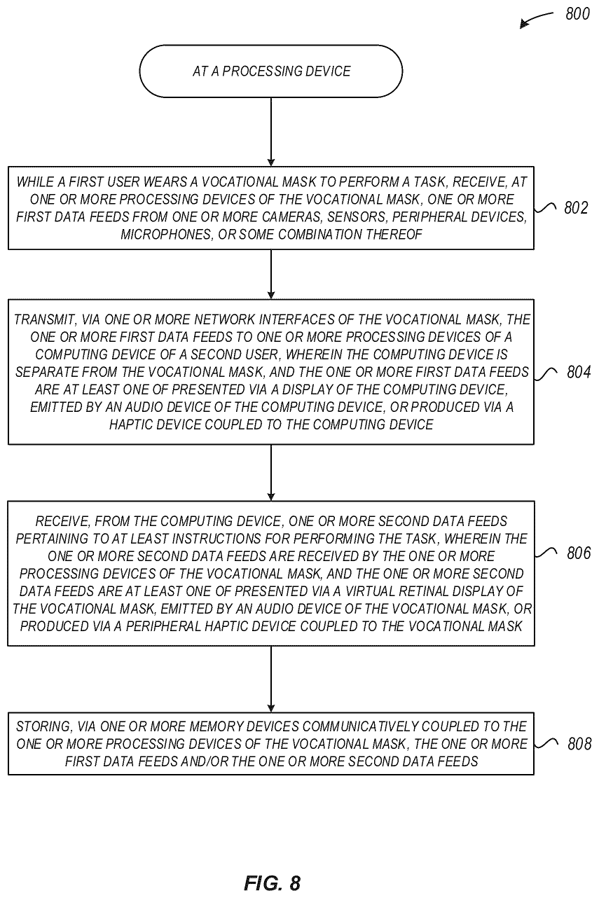

FIG. 8 illustrates an example of a method 800 for transmitting instructions for performing a task via bidirectional communication between a vocational mask and a computing device according to certain embodiments of this disclosure. The method 800 may be performed by processing logic that may include hardware (circuitry, dedicated logic, etc.), software, or a combination of both. The method 800 and/or each of their individual functions, subroutines, or operations may be performed by one or more processing devices of a computing device (e.g., any component (server 128, training engine 152, machine learning models 154, etc.) of cloud-based computing system 116, vocational mask 130, edge processor 132 (132.1, 132.2), peripheral haptic device 134, tool 136, and/or computing device 140 of FIG. 1) implementing the method 700. The method 800 may be implemented as computer instructions stored on a memory device and executable by the one or more processors. In certain implementations, the method 800 may be performed by a single processing thread. Alternatively, the method 800 may be performed by two or more processing threads, each thread implementing one or more individual functions, routines, subroutines, or operations of the methods.

For simplicity of explanation, the method 800 is depicted and described as a series of operations. However, operations in accordance with this disclosure can occur in various orders or concurrently, and with other operations not presented and described herein. For example, the operations depicted in the method 800 may occur in combination with any other operation of any other method disclosed herein. Furthermore, not all illustrated operations may be required to implement the method 800 in accordance with the disclosed subject matter. In addition, those skilled in the art will understand and appreciate that the method 800 could alternatively be represented as a series of interrelated states via a state diagram or events.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

At block 802, while a first user wears a vocational mask 130 to perform a task, the processing device may receive, at one or more processing devices of the vocational mask 130, one or more first data feeds from one or more cameras of the vocational mask 130, sensors of the vocational mask 130, peripheral haptic devices associated with the vocational mask 130, microphones of the vocational mask 130, or some combination thereof. In some embodiments, the vocational mask 130 may be attached to or integrated with a welding helmet and the task may be welding. In some embodiments, the task may be sanding, grinding, polishing, deburring, chamfering, coating, etc. The vocational mask 130 may be attached to or integrated with a helmet, a hat, goggles, binoculars, a monocular, or the like.

In some embodiments, the one or more first data feeds may include information related to video, images, audio, hand motions, haptics, texture, temperature, vibration, slipperiness, friction, wetness, pulsation, or some combination thereof. In some embodiments, the one or more first data feeds may include geographical position of the vocational mask 130, and the processing device may map, based on the geographical positon, the vocational mask 130 in an environment or a physical space in which the vocational mask 130 is located.

At block 804, the processing device may transmit, via one or more network interfaces of the vocational mask 130, the one or more first data feeds to one or more processing devices of the computing device 140 of a second user. In some embodiments, the computing device 140 of the second user may include one or more vocational masks, one or more smartphones, one or more tablets, one or more laptop computers, one or more desktop computers, one or more servers, or some combination thereof. The computing device 140 may be separate from the vocational mask 130, and the one or more first data feeds are at least one of presented via a display of the computing device 140, emitted by an audio device of the computing device 140, or produced or reproduced via a peripheral haptic device coupled to the computing device 140. In some embodiments, the first user may be an apprentice, student, trainee, or the like, and the second user may be a master user, a trainer, a teacher, a collaborator, a supervisor, or the like.

At block 806, the processing device may receive, from the computing device, one or more second data feeds pertaining to at least instructions for performing the task. The one or more second data feeds are received by the one or more processing devices of the vocational mask 130, and the one or more second data feeds are at least one of presented via a virtual retinal display of the vocational mask 130, emitted by an audio device (e.g., speaker) of the vocational mask 130, or produced or reproduced via a peripheral haptic device 134 coupled to the vocational mask 130.

In some embodiments, the instructions are presented, by the virtual retinal display of the vocational mask 130, via augmented reality. In some embodiments, the instructions are presented, by the virtual retinal display of the vocational mask, via virtual reality during a simulation associated with the task. In some embodiments, the processing device may cause the virtual retinal display to project an image onto at least one iris of the first user to display alphanumeric data associated with the instructions, graphics associated with the instructions, animations associated with the instructions, video associated with the instructions, or some combination thereof.

At block 808, the processing device may store, via one or more memory devices communicatively coupled to the one or more processing devices of the vocational mask 130, the one or more first data feeds and/or the one or more second data feeds.

In some embodiments, the processing device may cause the peripheral haptic device 134 to vibrate based on the instructions received from the computing device 140.

In some embodiments, the processing device may execute an artificial intelligence agent trained to perform at least one or more functions to determine certain information. The one or more functions may include (i) identifying perception-based objects and features, (ii) determining cognition-based scenery to identify one or more material defects, one or more assembly defects, one or more acceptable features, or some combination thereof, and (iii) determining one or more recommendations, instructions, or both.

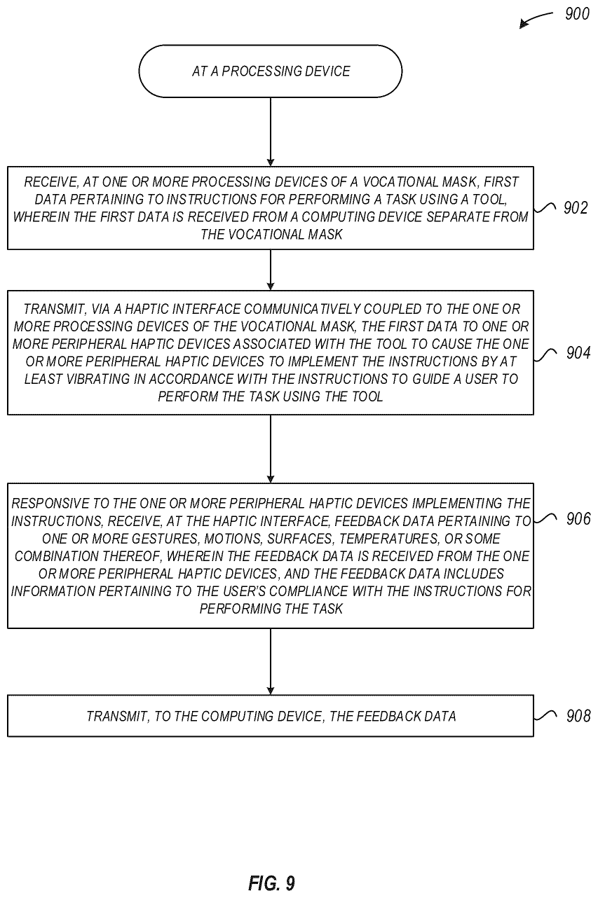

FIG. 9 illustrates an example of a method 900 for implementing instructions for performing a task using a peripheral haptic device according to certain embodiments of this disclosure. The method 900 may be performed by processing logic that may include hardware (circuitry, dedicated logic, etc.), software, or a combination of both. The method 900 and/or each of their individual functions, subroutines, or operations may be performed by one or more processing devices of a computing device (e.g., any component (server 128, training engine 152, machine learning models 154, etc.) of cloud-based computing system 116, vocational mask 130, edge processor 132 (132.1, 132.2), peripheral haptic device 134, tool 136, and/or computing device 140 of FIG. 1) implementing the method 900. The method 900 may be implemented as computer instructions stored on a memory device and executable by the one or more processors. In certain implementations, the method 900 may be performed by a single processing thread. Alternatively, the method 900 may be performed by two or more processing threads, each thread implementing one or more individual functions, routines, subroutines, or operations of the methods.

For simplicity of explanation, the method 900 is depicted and described as a series of operations. However, operations in accordance with this disclosure can occur in various orders or concurrently, and with other operations not presented and described herein. For example, the operations depicted in the method 900 may occur in combination with any other operation of any other method disclosed herein. Furthermore, not all illustrated operations may be required to implement the method 900 in accordance with the disclosed subject matter. In addition, those skilled in the art will understand and appreciate that the method 900 could alternatively be represented as a series of interrelated states via a state diagram or events.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

At block 902, the processing device may receive, at one or more processing devices of a vocational mask 130, first data pertaining to instructions for performing a task using a tool 136. The first data may be received from a computing device 140 separate from the vocational mask 130. In some embodiments, the computing device may include one or more peripheral haptic devices, one or more vocational masks, one or more smartphones, one or more tablets, one or more laptop computers, one or more desktop computers, one or more servers, or some combination thereof. In some embodiments, the task includes welding and the tool 136 is a welding gun.

At block 904, the processing device may transmit, via a haptic interface communicatively coupled to the one or more processing devices of the vocational mask 130, the first data to one or more peripheral haptic devices 134 associated with the tool 136 to cause the one or more peripheral haptic devices 134 to implement the instructions by at least vibrating in accordance with the instructions to guide a user to perform the task using the tool 136.

At block 906, responsive to the one or more peripheral haptic devices 134 implementing the instructions, the processing device may receive, from a haptic interface, feedback data pertaining to one or more gestures, motions, surfaces, temperatures, or some combination thereof. The feedback data may be received from the one or more peripheral haptic devices 134, and the feedback data may include information pertaining to the user's compliance with the instructions for performing the task.

At block 908, the processing device may transmit, to the computing device 140, the feedback data. In some embodiments, transmitting the feedback data may cause the computing device 140 to produce an indication of whether the user complied with the instructions for performing the task. The indication may be produced or generated via a display, a speaker, a different peripheral haptic device, or some combination thereof.

In some embodiments, in addition to the first data being received, video data may be received at the processing device of the vocational mask 130, and the video data may include video pertaining to the instructions for performing the task using the tool 136. In some embodiments, the processing device may display, via a virtual retinal display of the vocational mask 130, the video data. In some embodiments, the video data may be displayed concurrently with the instructions being implemented by the one or more peripheral haptic devices 134.

In some embodiments, in addition to the first data and/or video data being received, audio data may be received at the processing device of the vocational mask 130, and the audio data may include audio pertaining to the instructions for performing the task using the tool 136. In some embodiments, the processing device may emit, via a speaker of the vocational mask 130, the audio data. In some embodiments, the audio data may be emitted concurrently with the instructions being by the one or more peripheral haptic devices 134 and/or with the video data being displayed by the virtual retinal display. That is, one or more of video, audio, and/or haptic data pertaining to the instructions may be used concurrently to guide or instruct a user how to perform a task.

In some embodiments, in addition to the first data, video data, and/or audio data being received, virtual reality data may be received at the processing device of the vocational mask 130, and the virtual reality data may include virtual reality multimedia representing a simulation of a task. The processing device may execute, via at least a display of the vocational mask 130, playback of the virtual reality multimedia. For example, an artificial intelligent simulation generator may be configured to generate a virtual reality simulation for performing a task, such as welding an object using a welding gun. The virtual reality simulation may take into consideration various attributes, characteristics, parameters, and the like of the welding scenario, such as type of object being welded, type of welding, current amperage, length of arc, angle, manipulation, speed, and the like. The virtual reality simulation may be generated as multimedia that is presented via the vocational mask to a user to enable a user to practice, visualize, and experience performing certain welding tasks without actually welding anything.

In some embodiments, in addition to the first data, video data, audio data, and/or virtual reality data being received, augmented reality data may be received at the processing device of the vocational mask 130, and the augmented reality data may include augmented reality multimedia representing at least the instructions (e.g., via text, graphics, images, video, animation, audio). The processing device may execute, via at least a display of the vocational mask 130, playback of the augmented reality multimedia.

In some embodiments, the processing device may execute an artificial intelligence agent trained to perform at least one or more functions to determine certain information. The one or more functions may include (i) identifying perception-based objects and features, (ii) determining cognition-based scenery to identify one or more material defects, one or more assembly defects, one or more acceptable features, or some combination thereof, and/or (iii) determining one or more recommendations, instructions, or both. In some embodiments, the processing device may display, via a display (e.g., virtual retinal display or other display), the objects and features, the one or more material defects, the one or more assembly defects, the one or more acceptable features, the one or more recommendations, the instructions, or some combination thereof.

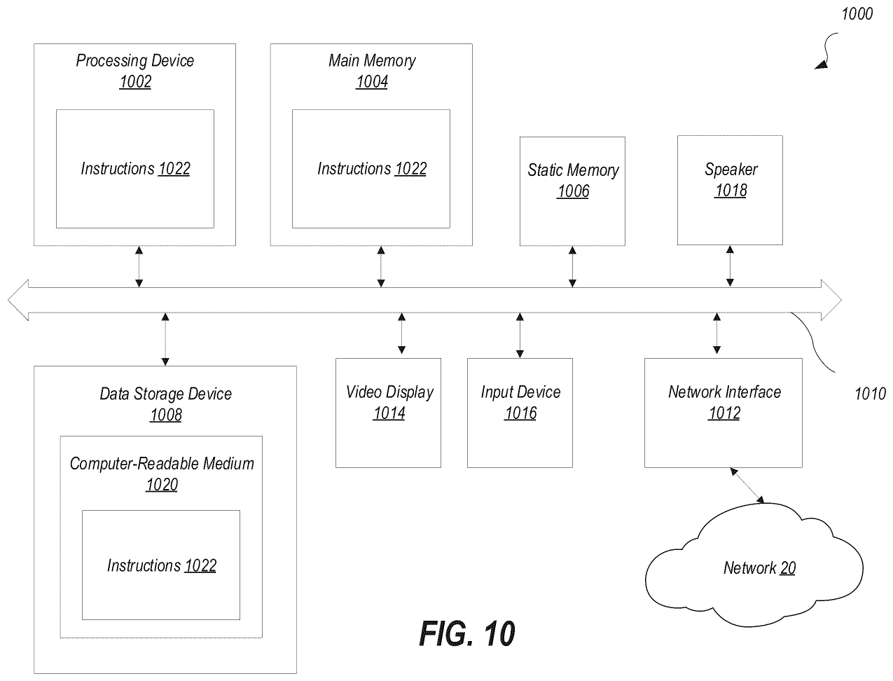

FIG. 10 illustrates an example computer system 1000, which can perform any one or more of the methods described herein. In one example, computer system 1000 may include one or more components that correspond to the vocational mask 130, the computing device 140, the peripheral haptic device 134, the tool 136, one or more servers 128 of the cloud-based computing system 116, or one or more training engines 152 of the cloud-based computing system 116 of FIG. 1. The computer system 1000 may be connected (e.g., networked) to other computer systems in a LAN, an intranet, an extranet, or the Internet. The computer system 1000 may operate in the capacity of a server in a client-server network environment. The computer system 1000 may be a personal computer (PC), a tablet computer, a laptop, a wearable (e.g., wristband), a set-top box (STB), a personal Digital Assistant (PDA), a smartphone, a smartwatch, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 1000 includes a processing device 1002, a main memory 1004 (e.g., read-only memory (ROM), solid state drive (SSD), flash memory, dynamic random access memory (DRAM) such as synchronous DRAM (SDRAM)), a static memory 1006 (e.g., solid state drive (SSD), flash memory, static random access memory (SRAM)), and a data storage device 1008, which communicate with each other via a bus 1010.

Processing device 1002 represents one or more general-purpose processing devices such as a microprocessor, central processing unit, or the like. More particularly, the processing device 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also be one or more special-purpose processing devices such as an application specific integrated circuit (ASIC), a field programmable gate array (FPGA), a digital signal processor (DSP), network processor, or the like. The processing device 1002 is configured to execute instructions for performing any of the operations and steps of any of the methods discussed herein.

The computer system 1000 may further include a network interface device 1012. The computer system 1000 also may include a video display 1014 (e.g., a liquid crystal display (LCD) or a cathode ray tube (CRT)), one or more input devices 1016 (e.g., a keyboard and/or a mouse), and one or more speakers 1018 (e.g., a speaker). In one illustrative example, the video display 1014 and the input device(s) 1016 may be combined into a single component or device (e.g., an LCD touch screen).

The data storage device 1008 may include a computer-readable medium 1020 on which the instructions 1022 embodying any one or more of the methodologies or functions described herein are stored. The instructions 1022 may also reside, completely or at least partially, within the main memory 1004 and/or within the processing device 1002 during execution thereof by the computer system 1000. As such, the main memory 1004 and the processing device 1002 also constitute computer-readable media. The instructions 1022 may further be transmitted or received over a network 20 via the network interface device 1012.

While the computer-readable storage medium 1020 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

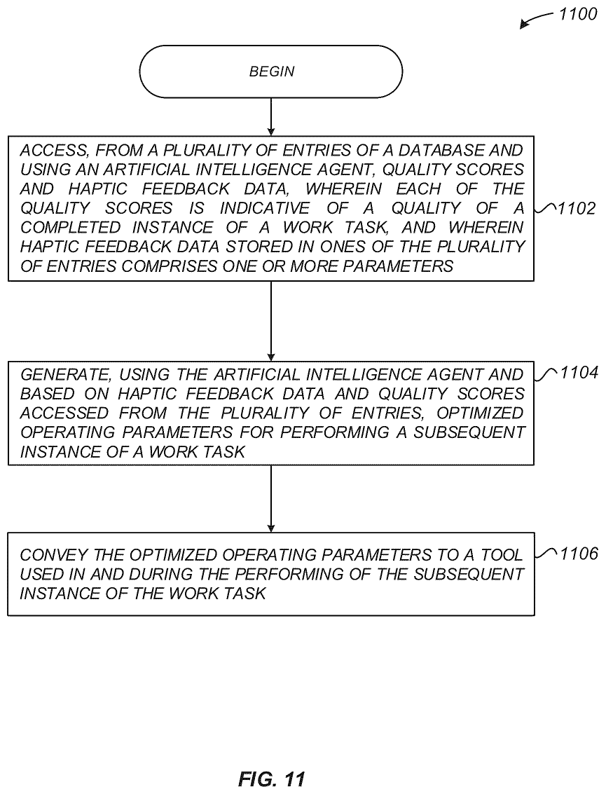

FIG. 11 is a flow diagram of one embodiment of a method for generating optimized operating parameters using an artificial intelligence agent. Method 1100 may be carried out in various embodiments of a computer system, including (but not limited to) cloud-based computing system 116 as discussed above. The method 1100 may be implemented in computer instructions stored on one or more memory device and executed by one or more processing devices.

Method 1100 includes accessing, from a plurality of entries of a database and using an artificial intelligence agent, quality scores and haptic feedback data, wherein each of the quality scores is indicative of a quality of a completed instance of a work task, and wherein haptic feedback data stored in ones of the plurality of entries comprises one or more parameters (1102). The method further includes generating, using the artificial intelligence agent and based on haptic feedback data and quality scores accessed from the plurality of entries, optimized operating parameters for performing a subsequent instance of a work task (1104). After completing generating the optimized operating parameters, the method further includes transmitting the optimized operating parameters to a tool used in and during the performing of the subsequent instance of the work task (1106).

In various embodiments, the optimized operating parameters may be updated as additional instances of the work task are completed. Each of the additional instances of the work task may result in additional haptic data and corresponding quality scores being stored in the database. Using this additional information, the artificial intelligence agent may further refine the optimized operating parameters, or may confirm that the current operating parameters are optimal.

The operating parameters may include a voltage, a current, a temperature, vibrations to guide the tool, wire feed speed, and so on. Generally speaking, any operating parameters of the tool that affect performance and/or quality of the completed work task may be determined and optimized by the artificial intelligence agent.

In addition to using haptic feedback data, the artificial intelligence agent may, in some embodiments, utilize image data from a completed instance of the job. For example, a vocational mask as discussed above may capture one or more images of the completed work task (e.g., a weld joint, a solder joint, etc.) and send these images along with the haptic feedback data. The artificial intelligence agent may in various embodiments utilize the image data to determine a corresponding quality score for the completed instance of the work task. The image data may be stored in the database along with the quality scores and the haptic feedback data.

In addition to generating optimized parameters, the artificial intelligence agent may generate additional information to be transmitted along with the optimized parameters. For example, the artificial intelligence agent may also generate updated directions for performing the work task based on the information from previously completed instances. Tips/recommendations for performing the work task in a more efficient or effective manner may also be included. This information may, in one example, be transmitted to a user wearing a vocational mask and presented through a display therein. Also, the information may be emitted via one or more speakers of the vocational mask and/or provided as vibrations via the haptic peripheral device. The disclosure also contemplates robotic entities performing the task, and thus the information may be transmitted thereto in a suitable format.

The artificial intelligence agent used to generate optimized operating parameters may be based on a machine learning model that is trained in various ways. In one embodiment, initial training of the machine learning model (and thus the artificial intelligence agent) may include supervised learning. The supervised learning may use training data that includes labeled inputs (e.g., quality of welds performed in various work settings) mapped to labeled outputs (e.g., operating parameters to control the tool). After it is determined that the artificial intelligence agent, using the machine learning model, is proficient in generating optimized operating parameters, subsequent training may be carried out using unsupervised learning.

In some embodiments, the generation of quality scores may be carried out by the artificial intelligence agent itself based on, e.g., image data of corresponding instances of the competed work task. In other embodiments, the quality scores may be manually input, or generated by another artificial intelligence agent executed on an edge processor closer to the work tool and thus the location at which the work task is performed.

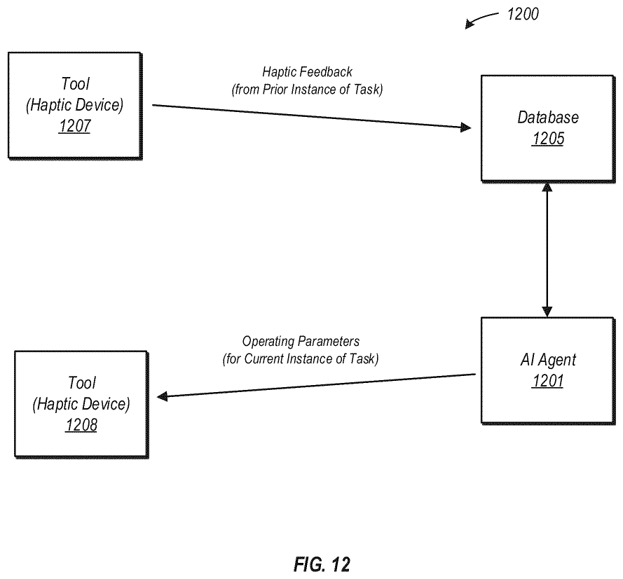

FIG. 12 is a block diagram illustrating one embodiment of a system including a database, an artificial intelligence agent, and tools for performing a work task. In the embodiment shown, system 1200 includes a database 1205, an artificial intelligence agent 1201, a tool 1207 (which may also be a haptic device) and another instance of a tool/haptic device 1208. In various embodiment, database 1205 and artificial intelligence agent 1201 may be located/executed in a cloud computing system, such as cloud-based computing system 116 of FIG. 1.

Database 1205 in the embodiment shown is configured to receive haptic feedback from tool/haptic device 1207 during the performance of a work task. The haptic feedback may be generated by an entity such as a user operating the tool or some other entity, such as a robot. The providing of haptic data to database 1205 may occur over a number of instances of performing the job. Database 1205 may include a plurality of entries, each of which stores haptic feedback data for a particular instance of the work task. Each of these entries may also store quality scores and/or other information, such as images of the completed work task.

Artificial intelligence agent 1201 may access the entries of database 1205 to generate optimized operating parameters for performing subsequent instances of the work task. The optimized operating parameters may be generated by associating haptic feedback data with various quality scores. In some embodiments, a quality score may comprise multiple values that indicate the quality of particular aspects of the work task. For example, if the completed work task is a weld joint, the quality score may include a value indicative of a uniform finish, a value indicative of the correct weld size/length, a value indicating the presence/absence of defects, a value indicative of a transition between the weld and the base material, a value indicative of surface discoloration, and so on. Artificial intelligence agent 1201 may, based on those multiple values and the haptic feedback data, generate the optimized operating parameters. Furthermore, the optimized operating parameters may be updated as additional instances of the work task are performed.

When a new instance of the work task is to be performed, the artificial intelligence agent 1201 may transmit the current optimized operating parameters to the work tool/haptic device 1208. In one embodiment, upon beginning the performance of another instance of the work task, the tool/haptic device 1208 may send a query to the artificial intelligence agent for the optimized parameters. In some embodiments, the optimized parameters may be sent as information, with a user setting the parameters in the tool/haptic device based on the information. In other embodiments, the artificial intelligence agent itself may automatically set the parameters without intervention of a user.

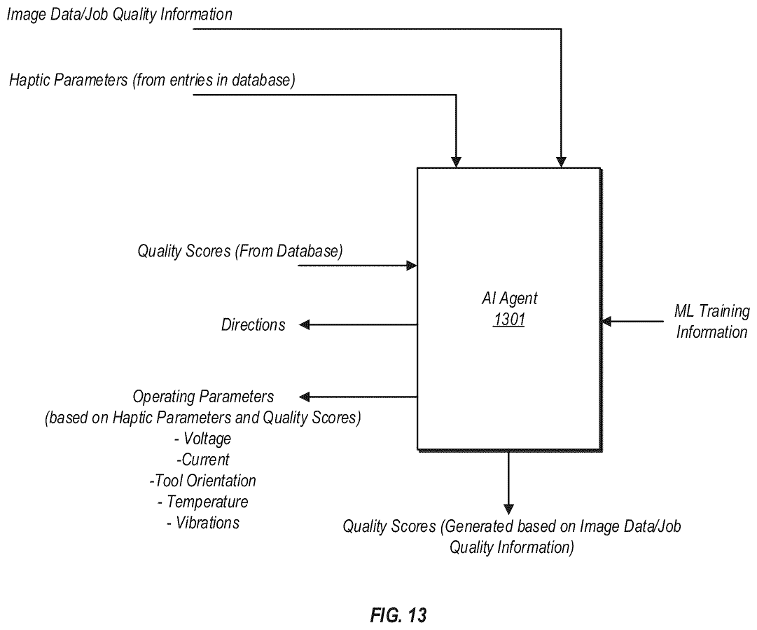

FIG. 13 is a block diagram of an example artificial intelligence agent. In the embodiment shown, the artificial intelligence agent 1301 may receive training information from a machine learning model. The training information may be used to determine how artificial intelligence agent 1301 evaluates the various inputs received during operation. For operation of the embodiment shown, these inputs include haptic parameters (or haptic feedback data) accessed from a database, along with job quality information and, in some cases image data. The job quality information may include one or more quality scores for each instance of a completed work task. The quality score may indicate an overall quality of the job in some embodiments. In embodiments in which multiple quality scores are generate for each instance of a completed work task, a given quality score may refer to the quality of a particular aspect of the task.

In some embodiments, the quality scores may be manually input into artificial intelligence agent 1301. However, the disclosure contemplates embodiments in which the artificial intelligence agent 1301 generates the quality scores using, e.g., image data. For example, after completing an instance of a work task, one or more images of the completed work may be generated and transmitted to the database along with the haptic feedback data that was also generated during performance of the task. The artificial intelligence agent 1301 may utilize training from a machine learning model to evaluate the quality of the work task using the image data received. The image data, the quality scores, and the haptic feedback data for a given instance of a work task may all be stored in an entry of the database, with the common storage of these items in a single database entry indicating correlation among them.

Using the quality scores and the haptic parameters from the various entries in the database, artificial intelligence agent 1301 may generate optimized operating parameters to be used for future instances of performing the work task. Example parameters, as listed in the drawing, include voltage, current tool orientation, temperature, and haptic vibrations. It is noted however, this list of possible parameters is not intended to be limiting or exhaustive in any way, and thus the generation of other (or additional) optimized parameters are possible and contemplated within the scope of this disclosure. Generally speaking, any optimal operating parameters pertinent to a particular work task may be determined by a given implementation of artificial intelligence agent 1301.

In addition to optimized parameters, artificial intelligence agent 1301 in some embodiments may also generate directions for performing the work task. In some cases, these directions may be directions that have been modified from original directions based on the data history stored in the database. The directions may include both specific instructions for performing the task, as well as tips, recommendations, and generally useful information that may enhance the effectiveness of an entity that is actually performing the work task.

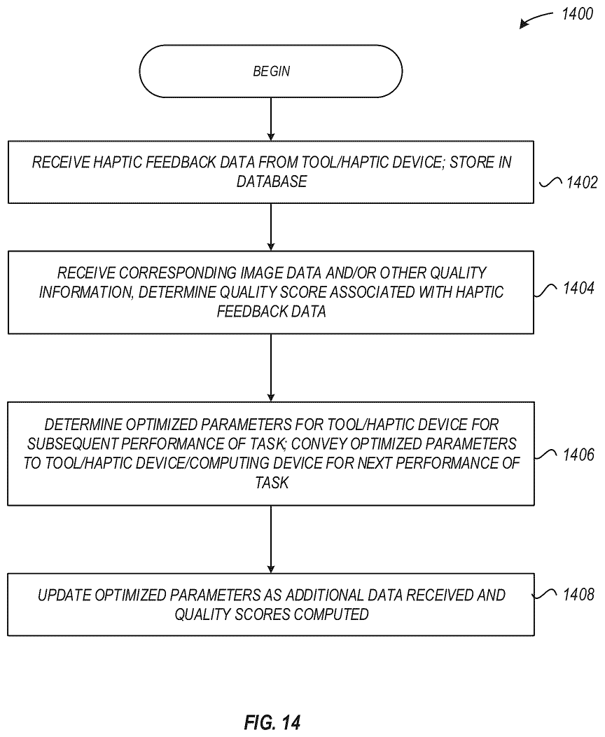

FIG. 14 is a illustrating an embodiment of a method 1400 for generating and updating optimized operating parameters using an artificial intelligence agent. The method 1400 may be implemented in computer instructions stored on one or more memory devices and executed by one or more processing devices. Method 1400 includes receiving haptic feedback data from a tool/haptic device during performance of a work task and storing this data in a database (1402). The method further includes receiving corresponding image data and/or other quality information for the given instance of the work task and determining a quality score associated with the haptic feedback data (1404). This information may then be stored in an entry of the database along with the haptic feedback data itself.

The method further includes the artificial intelligence agent determining optimized parameters for a tool/haptic device using in performing the work task for subsequent instances of the same (1406). The optimized parameters are transmitted to the tool/haptic device during a subsequent instance of performing the task. The method also includes updating the optimized parameters as additional data is received and additional quality scores are computed (1408).

More generally, embodiments of the method contemplate receiving, at a database, a quality score and haptic feedback data, wherein the haptic feedback data is generated during performance of a first instance of a work task, and wherein the quality score is indicative of a quality of results of the first instance of the work task upon completion. Such embodiments also include storing the haptic feedback data and the quality score in a first entry of the database, wherein the database includes a plurality of entries including the first entry, and wherein other entries of the plurality of entries store respective quality scores and haptic feedback data for other instances of the work task. Thereafter, various embodiments of the method include generating, using an artificial intelligence agent and based on haptic feedback data and quality scores stored in various ones of the plurality of entries, optimized operating parameters for performing a subsequent instance of the work task, and transmitting, during a subsequent instance of performing the work task, the optimized operating parameters to a haptic device used in performing the work task.

Embodiments of a method may include generating, using at least one haptic device and during the performing of a work task, haptic feedback data comprising one or more parameters, and generating, in response to completing the work task, a quality score indicative of a quality of results of the work task. The methods may include storing, in a database, the quality score and the haptic feedback data, wherein the database includes a plurality of entries storing respective quality scores and respective haptic feedback data for other instances of the work task. Thereafter, embodiments of the method may include generating, using an artificial intelligence agent and based on haptic feedback data and quality scores stored in various ones of the plurality of entries, optimized operating parameters for performing a subsequent instance of the work task, and managing, using the optimized operating parameters, haptic feedback during the performing of the subsequent instance of the work task.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

### CLAUSES

Clause 1. A system comprising:
   a vocational mask configured to be worn by a user, wherein the vocational mask comprises:
   a virtual retinal display;
   a memory device storing instructions;
   a processing device communicatively coupled to the memory device and the virtual retinal display, wherein the processing device executes the instructions to:
   execute an artificial intelligence agent trained to perform at least one or more functions to determine certain information, wherein the one or more functions comprise:
   identifying perception-based objects and features,
   determining cognition-based scenery to identify one or more material defects, one or more assembly defects, one or more acceptable features, or some combination thereof, and
   determining one or more recommendations, instructions, or both; and
   cause the certain information to be presented via the virtual retinal display.
Clause 2. The system of any clause herein, wherein the virtual retinal display projects an image onto at least one iris of the user to display alphanumeric data, graphic instructions, animated instructions, video instructions, or some combination thereof.
Clause 3. The system of any clause herein, wherein the vocational mask further comprises a network interface configured to enable bidirectional communication with a second network interface of a second vocational mask, and the bidirectional communication enables transmission of real-time or near real-time audio and video data, recorded audio and video data, or some combination thereof.
Clause 4. The system of any clause herein, further comprising a peripheral haptic device, wherein:
   the vocational mask further comprises a haptic interface, and wherein the haptic interface is configured to perform bidirectional haptic sensing and stimulation using the peripheral haptic device and the bidirectional communication, and wherein the stimulation comprises performing mimicked gestures via the peripheral haptic device.
Clause 5. The system of any clause herein, wherein the bidirectional communication enables a master user of the second vocational mask to view and/or listen to the real-time or near real-time audio and video data, recorded audio and video data, or some combination thereof, and to provide instructions to the user via the vocational mask.
Clause 6. The system of any clause herein, wherein bidirectional
   communication enables the user of the vocational mask to provide instructions to a plurality of students via a plurality of vocational masks.
Clause 7. The system of any clause herein, wherein bidirectional communication enables the user of the vocational mask to provide instructions to a plurality of students via a plurality of computing devices.
Clause 8. The system of any clause herein, wherein bidirectional communication enables a collaborator or teacher to receive, using a computing device, audio data, video data, haptic data, or some combination thereof, from the vocational mask being used by the user.
Clause 9. The system of any clause herein, further comprising a cloud-based computing system communicatively coupled to the vocational mask, wherein:
   the cloud-based computing system determines one or more parameters by training a cloud-based artificial intelligence agent using training data to perform the one or more functions, and
   the cloud-based computing system transmits the one or more parameters to the vocational mask to train the artificial intelligence agent.
Clause 10. The system of any clause herein, wherein the vocational mask further comprises a haptic interface communicatively coupled to the processing device, wherein the haptic interface is configured to sense hand motions, texture, temperature, vibration, slipperiness, friction, wetness, pulsation, or some combination thereof.
Clause 11. The system of any clause herein, wherein the system further comprises a welding helmet and the vocational mask is coupled to the welding helmet.
Clause 12. The system of any clause herein, wherein the vocational mask further comprises a stereo speaker to emit audio pertaining to the certain information.
Clause 13. The system of any clause herein, wherein the vocational mask further comprises one or more sensors to provide information related to geographical position, pose of the user, rotational rate of pose of the user, or some combination thereof.
Clause 14. The system of any clause herein, wherein the vocational mask further comprises one or more sensors comprising vocation imaging band specific cameras, visual band cameras, stereo microphones, acoustic sensors, or some combination thereof.
Clause 15. The system of any clause herein, wherein the vocational mask further comprises an optical bench that aligns the virtual retinal display to one or more eyes of the user.
Clause 16. The system of any clause herein, wherein the processing device executes the instructions to superposition the certain information on a display.
Clause 17. The system of any clause herein, wherein the vocational mask is configured to operate across both visible light and high intensity ultraviolet light conditions.
Clause 18. The system of any clause herein, wherein the processing device is configured to record the certain information, communications with other devices, or both.
Clause 19. The system of any clause herein, wherein the vocational mask provides protection against welding flash.
Clause 20. The system of any clause herein, wherein the processing device executes the instructions to map the vocational mask in a physical space in which the vocational mask is located.
Clause 21. The system of any clause herein, wherein the vocational mask comprises goggles.
Clause 22. A vocational mask configured to be worn by a user, wherein the vocational mask comprises:
   a virtual retinal display;
   a memory device storing instructions;
   a processing device communicatively coupled to the memory device and the virtual retinal display, wherein the processing device executes the instructions to:
   execute an artificial intelligence agent trained to perform at least one or more functions to determine certain information, wherein the one or more functions comprise:
   identifying perception-based objects and features,
   determining cognition-based scenery to identify one or more material defects, one or more assembly defects, one or more acceptable features, or some combination thereof, and
   determining one or more recommendations, instructions, or both; and
   cause the certain information to be presented via the virtual retinal display.
Clause 23. A computer-implemented method comprising:
   executing, by one or more processing devices of a vocational mask, an artificial intelligence agent trained to perform at least one or more functions to determine certain information, wherein the one or more functions comprise:
   identifying perception-based objects and features,
   determining cognition-based scenery to identify one or more material defects, one or more assembly defects, one or more acceptable features, or some combination thereof, and
   determining one or more recommendations, instructions, or both; and
   causing, by the one or more processing devices, the certain information to be presented via a virtual retinal display of the vocational mask.
Clause 24. The method of any clause herein 77: wherein the processing device stores communications in the memory device, wherein the communications are between the vocational mask and another vocational mask, the vocational mask and a computing device, or both.
Clause 25. A system comprising:
   goggles configured to be worn by a user, wherein the goggles comprise:
   a display;
   a memory device storing instructions;
   a processing device communicatively coupled to the memory device and the display, wherein the processing device executes the instructions to:
   execute an artificial intelligence agent trained to perform at least one or more functions to determine certain information, wherein the one or more functions comprise: identifying perception-based objects and features,
   determining cognition-based scenery to identify one or more material defects, one or more assembly defects, one or more acceptable features, or some combination thereof, and
   determining one or more recommendations, instructions, or both; and
   cause the certain information to be presented via the display.
Clause 26. A system comprising:
   a monocular welding goggle configured to be worn by a user, wherein the monocular welding goggle comprises:
   a display;
   a memory device storing instructions;
   a processing device communicatively coupled to the memory device and the display, wherein the processing device executes the instructions to:
   execute an artificial intelligence agent trained to perform at least one or more functions to determine certain information, wherein the one or more functions comprise: identifying perception-based objects and features,
   determining cognition-based scenery to identify one or more material defects, one or more assembly defects, one or more acceptable features, or some combination thereof, and
   determining one or more recommendations, instructions, or both; and
   cause the certain information to be presented via the display.
Clause 27. A computer-implemented method comprising:
   while a first user wears a vocational mask to perform a task, receiving, at one or more processing devices of the vocational mask, one or more first data feeds from one or more cameras, sensors, peripheral haptic devices, microphones, or some combination thereof;
   transmitting, via one or more network interfaces of the vocational mask, the one or more first data feeds to one or more processing devices of a computing device of a second user, wherein the computing device is separate from the vocational mask, and the one or more first data feeds are at least one of presented via a display of the computing device, emitted by an audio device of the computing device, or produced via a haptic device coupled to the computing device;
   receiving, from the computing device, one or more second data feeds pertaining to at least instructions for performing the task, wherein the one or more second data feeds are received by the one or more processing devices of the vocational mask, and the one or more second data feeds are at least one of presented via a virtual retinal display of the vocational mask, emitted by an audio device of the vocational mask, or produced via a peripheral haptic device coupled to the vocational mask; and
   storing, via one or more memory devices communicatively coupled to the one or more processing devices of the vocational mask, the one or more first data feeds and/or the one or more second data feeds.
Clause 28. The computer-implemented method of any clause herein, wherein the computing device comprises one or more other vocational masks, one or more smartphones, one or more tablets, one or more laptop computers, one or more desktop computers, one or more servers, or some combination thereof.
Clause 29. The computer-implemented method of any clause herein, further comprising executing an artificial intelligence agent trained to perform at least one or more functions to determine certain information, wherein the one or more functions comprise: identify perception-based objects and features,
   determine cognition-based scenery to identify one or more material defects, one or more assembly defects, one or more acceptable features, or some combination thereof, and
   determine one or more recommendations, instructions, or both.
Clause 30. The computer-implemented method of any clause herein, wherein the instructions are presented, by the virtual retinal display of the vocational mask, via augmented reality.
Clause 31. The computer-implemented method of any clause herein, wherein the instructions are presented, by the virtual retinal display of the vocational mask, via virtual reality during a simulation associated with the task.
Clause 32. The computer-implemented method of any clause herein, further comprising causing the peripheral haptic device to vibrate based on the instructions received from the computing device.
Clause 33. The computer-implemented method of any clause herein, further comprising causing the virtual retinal display to project an image onto at least one iris of the first user to display alphanumeric data associated with the instructions, graphics associated with the instructions, animations associated with the instructions, video associated with the instructions, or some combination thereof.
Clause 34. The computer-implemented method of any clause herein, wherein the first user is an apprentice and the second user is a master.
Clause 35. The computer-implemented method of any clause herein, wherein the vocational mask is attached to a welding helmet and the task is welding.
Clause 36. The computer-implemented method of any clause herein, wherein the one or more first data feeds comprise information related to video, images, audio, haptics, hand motions, texture, temperature, vibration, slipperiness, friction, wetness, pulsation, or some combination thereof.
Clause 37. The computer-implemented method of any clause herein, wherein the one or more first data feeds comprise geographical position of the vocational mask, and the method further comprises:

mapping, based on the geographical position, the vocational mask in a physical space in which the vocational mask is located.
Clause 38. The computer-implemented method of any clause herein, wherein the vocational mask comprises goggles.
Clause 39. A tangible, non-transitory computer-readable medium storing computer instructions that, when executed, cause one or more processing devices of a vocational mask to:
   while a first user wears the vocational mask to perform a task, receive, at the one or more processing devices of the vocational mask, one or more first data feeds from one or more cameras, sensors, peripheral haptic devices, microphones, or some combination thereof;
   transmit, via one or more network interfaces of the vocational mask, the one or more first data feeds to one or more processing devices of a computing device of a second user, wherein the computing device is separate from the vocational mask, and the one or more first data feeds are at least one of presented via a display of the computing device, emitted by an audio device of the computing device, or produced via a peripheral haptic device coupled to the computing device;
   receive, from the computing device, one or more second data feeds pertaining to at least instructions for performing the task, wherein the one or more second data feeds are received by the one or more processing devices of the vocational mask, and the one or more second data feeds are at least one of presented via a virtual retinal display of the vocational mask, emitted by an audio device of the vocational mask, or produced via a peripheral haptic device coupled to the vocational mask; and
   store, via one or more memory devices communicatively coupled to the one or more processing devices of the vocational mask, the one or more first data feeds and/or the one or more second data feeds.
Clause 40. The computer-readable medium of any clause herein, wherein the computing device comprises one or more other vocational masks, one or more smartphones, one or more tablets, one or more laptop computers, one or more desktop computers, one or more servers, or some combination thereof.
Clause 41. The computer-readable medium of any clause herein, wherein the one or more processing devices are further to execute an artificial intelligence agent trained to perform at least one or more functions to determine certain information, wherein the one or more functions comprise:
   identify perception-based objects and features,
   determine cognition-based scenery to identify one or more material defects, one or more assembly defects, one or more acceptable features, or some combination thereof, and
   determine one or more recommendations, instructions, or both.
Clause 42. The computer-readable medium of any clause herein, wherein the instructions are presented, by the virtual retinal display of the vocational mask, via augmented reality.
Clause 43. The computer-readable medium of any clause herein, wherein the instructions are presented, by the virtual retinal display of the vocational mask, via virtual reality during a simulation associated with the task.
Clause 44. The computer-readable medium of any clause herein, wherein the one or more processing devices are further to cause the peripheral haptic device to vibrate based on the instructions received from the computing device.
Clause 45. The computer-readable medium of any clause herein, wherein the one or more processing devices are further to cause the virtual retinal display to project an image onto at least one iris of the first user to display alphanumeric data associated with the instructions, graphics associated with the instructions, animations associated with the instructions, video associated with the instructions, or some combination thereof.
Clause 46. A system comprising:
   a vocational mask configured to be worn by a user, wherein the vocational mask comprises:
   one or more memory devices storing instructions; and
   one or more processing devices communicatively coupled to the one or more memory devices, wherein the one or more processing devices execute instructions to:
   while a first user wears the vocational mask to perform a task, receive, at the one or more processing devices of the vocational mask, one or more first data feeds from one or more cameras, sensors, peripheral haptic devices, microphones, or some combination thereof;
   transmit, via one or more network interfaces of the vocational mask, the one or more first data feeds to one or more processing devices of a computing device of a second user, wherein the computing device is separate from the vocational mask, and the one or more first data feeds are at least one of presented via a display of the computing device, emitted by an audio device of the computing device, or produced via a haptic device coupled to the computing device;
   receive, from the computing device, one or more second data feeds pertaining to at least instructions for performing the task, wherein the one or more second data feeds are received by the one or more processing devices of the vocational mask, and the one or more second data feeds are at least one of presented via a virtual retinal display of the vocational mask, emitted by an audio device of the vocational mask, or produced via a peripheral haptic device coupled to the vocational mask, and; and
   store, via one or more memory devices communicatively coupled to the one or more processing devices of the vocational mask, the one or more first data feeds and/or the one or more second data feeds.
Clause 47. A computer-implemented method comprising:
   receiving, at one or more processing devices of a vocational mask, first data pertaining to instructions for performing a task using a tool, wherein the first data is received from a computing device separate from the vocational mask;
   transmitting, via a haptic interface communicatively coupled to the one or more processing devices of the vocational mask, the first data to one or more peripheral haptic devices associated with the tool to cause the one or more peripheral haptic devices to implement the instructions by at least vibrating in accordance with the instructions to guide a user to perform the task using the tool;
   responsive to the one or more peripheral haptic devices implementing the instructions, receiving feedback data pertaining to one or more gestures, motions, surfaces, temperatures, or some combination thereof, wherein the feedback data is received from the one or more peripheral haptic devices, and the feedback data comprises information pertaining to the user's compliance with the instructions for performing the task; and
   transmitting, to the computing device, the feedback data.
Clause 48. The computer-implemented method of any clause herein, wherein transmitting the feedback data causes the computing device to produce an indication of whether the user complied with the instructions for performing the task, wherein the indication is produced via a display, a speaker, a different peripheral haptic device, or some combination thereof.
Clause 49. The computer-implemented method of any clause herein, further comprising:
   receiving, at the one or more processing devices of the vocational mask, second data comprising video pertaining to the instructions for performing the task using the tool; and
   displaying, via a virtual retinal display of the vocational mask, the second data.
Clause 50. The computer-implemented method of any clause herein, further comprising:
   receiving, at the one or more processing devices of the vocational mask, second data comprising audio pertaining the instructions for performing the task using the tool; and
   emitting, via a speaker of the vocational mask, the second data.
Clause 51. The computer-implemented method of any clause herein, further comprising:
   receiving, at the one or more processing devices of the vocational mask, second data comprising virtual reality multimedia representing a simulation of the task; and
   executing, via at least a display of the vocational mask, playback of the virtual reality multimedia.
Clause 52. The computer-implemented method of any clause herein, further comprising:
   receiving, at the one or more processing devices of the vocational mask, second data comprising augmented reality multimedia representing at least the instructions; and
   executing, via at least a display of the vocational mask, playback of the augmented reality multimedia.
Clause 53. The computer-implemented method of any clause herein, wherein the computing device comprises one or more other peripheral haptic devices, one or more other vocational masks, one or more smartphones, one or more tablets, one or more laptop computers, one or more desktop computers, one or more servers, or some combination thereof.
Clause 54. The computer-implemented method of any clause herein, wherein the task comprises welding and the tool comprises a welding gun.
Clause 55. The computer-implemented method of any clause herein, further comprising executing an artificial intelligence agent trained to perform at least one or more functions to determine certain information, wherein the one or more functions comprise: identify perception-based objects and features,
   determine cognition-based scenery to identify one or more material defects, one or more assembly defects, one or more acceptable features, or some combination thereof, and
   determine one or more recommendations, instructions, or both.
Clause 56. The computer-implemented method of any clause herein, further comprising displaying, via a display, the objects and features, the one or more material defects, the one or more assembly defects, the one or more acceptable features, the one or more recommendations, the instructions, or some combination thereof.
Clause 57. A tangible, non-transitory computer-readable medium storing instructions that, when executed, cause one or more processing devices of a vocational mask to:
   receive, at the one or more processing devices of the vocational mask, first data pertaining to instructions for performing a task using a tool, wherein the first data is received from a computing device separate from the vocational mask;
   transmit, via a haptic interface communicatively coupled to the one or more processing devices of the vocational mask, the first data to one or more peripheral haptic devices associated with the tool to cause the one or more peripheral haptic devices to implement the instructions by at least vibrating in accordance with the instructions to guide a user to perform the task using the tool;
   responsive to the one or more peripheral haptic devices implementing the instructions, receive feedback data pertaining to one or more gestures, motions, surfaces, temperatures, or some combination thereof, wherein the feedback data is received from the one or more peripheral haptic devices, and the feedback data comprises information pertaining to the user's compliance with the instructions for performing the task; and transmit, to the computing device, the feedback data.
Clause 58. The computer-readable medium of any clause herein, wherein transmitting the feedback data causes the computing device to produce an indication of whether the user complied with the instructions for performing the task, wherein the indication is produced via a display, a speaker, a different peripheral haptic device, or some combination thereof.
Clause 59. The computer-readable medium of any clause herein, wherein the one or more processing devices are further to:
   receive, at the one or more processing devices of the vocational mask, second data comprising video pertaining to the instructions for performing the task using the tool; and
   display, via a virtual retinal display of the vocational mask, the second data.
Clause 60. The computer-readable medium of any clause herein, wherein the one or more processing devices are further to:
   receive, at the one or more processing devices of the vocational mask, second data comprising audio pertaining the instructions for performing the task using the tool; and
   emit, via a speaker of the vocational mask, the second data.
Clause 61. The computer-readable medium of any clause herein, wherein the one or more processing devices are further to:
   receive, at the one or more processing devices of the vocational mask, second data comprising virtual reality multimedia representing a simulation of the task; and
   execute, via at least a display of the vocational mask, playback of the virtual reality multimedia.
Clause 62. The computer-readable medium of any clause herein, wherein the one or more processing devices are further to:
   receive, at the one or more processing devices of the vocational mask, second data comprising augmented reality multimedia representing at least the instructions; and
   execute, via at least a display of the vocational mask, playback of the augmented reality multimedia.
Clause 63. The computer-readable medium of any clause herein, wherein the computing device comprises one or more other peripheral haptic devices, one or more other vocational masks, one or more smartphones, one or more tablets, one or more laptop computers, one or more desktop computers, one or more servers, or some combination thereof.
Clause 64. The computer-readable medium of any clause herein, wherein the task comprises welding and the tool comprises a welding gun.
Clause 65. The computer-readable medium of any clause herein, wherein the one or more processing devices are further to execute an artificial intelligence agent trained to perform at least one or more functions to determine certain information, wherein the one or more functions comprise:
   identifying perception-based objects and features,
   determining cognition-based scenery to identify one or more material defects, one or more assembly defects, one or more acceptable features, or some combination thereof, and
   determining one or more recommendations, instructions, or both.
Clause 66. A system comprising:
   a vocational mask configured to be worn by a user, wherein the vocational mask comprises:
   one or more memory devices storing instructions;
   one or more processing devices communicatively coupled to the one or more memory devices, wherein the one or more processing devices execute the instructions to:
   receive, at the one or more processing devices of the vocational mask, first data pertaining to instructions for performing a task using a tool, wherein the first data is received from a computing device separate from the vocational mask;
   transmit, via a haptic interface communicatively coupled to the one or more processing devices of the vocational mask, the first data to one or more peripheral haptic devices associated with the tool to cause the one or more peripheral haptic devices to implement the instructions by at least vibrating in accordance with the instructions to guide a user to perform the task using the tool;
   responsive to the one or more peripheral haptic devices implementing the instructions, receive feedback data pertaining to one or more gestures, motions, surfaces, temperatures, or some combination thereof, wherein the feedback data is received from the one or more peripheral haptic devices, and the feedback data comprises information pertaining to the user's compliance with the instructions for performing the task; and transmit, to the computing device, the feedback data.
Clause 67: A method comprising:
   accessing, from a plurality of entries of a database and using an artificial intelligence agent, quality scores and haptic feedback data, wherein each of the quality scores is indicative of a quality of a completed instance of a work task, and wherein haptic feedback data stored in ones of the plurality of entries comprises one or more parameters;
   generating, using the artificial intelligence agent and based on haptic feedback data and quality scores accessed from the plurality of entries, optimized operating parameters for performing a subsequent instance of a work task; and
   transmitting the optimized operating parameters to a tool used in and during the performing of the subsequent instance of the work task.
Clause 68: The method of any clause herein, wherein the optimized operating parameters include information indicative of an orientation of a tool used in performing the work task.
Clause 69: The method of any clause herein, wherein the optimized operating parameters include a value of voltage provided to a tool used in performing the work task.
Clause 70: The method of any clause herein, wherein the optimized operating parameters include a value of an electrical current provided to a tool used in performing the work task.
Clause 71: The method of any clause herein, wherein the optimized operating parameters include a value of a temperature of generated by a tool used in performing the work task.
Clause 72: The method of any clause herein, wherein the optimized operating parameters include one or more vibrations that provide guidance to an entity for performing the work task.
Clause 73: The method of any clause herein, further comprising repeating, using the artificial intelligence agent, the generating of the optimized operating parameters based on haptic feedback data and quality scores corresponding to one or more subsequent completed instances of the work task.
Clause 74: The method of any clause herein, wherein the tool is a haptic device, and wherein the method further comprises transmitting the updated ones of the optimized operating parameters to the haptic device used in and during the subsequent instance of performing the work task.
Clause 75: The method of any clause herein, further comprising:
   accessing, by the artificial intelligence agent, image data stored in ones of the plurality of entries, wherein the image data stored in a particular one of the plurality of entries corresponds to a completed instance of the work task; and
   generating, using the image data by the artificial intelligence agent, the optimized operating parameters for performing a subsequent instance of a work task.
Clause 76: The method of any clause herein, further comprising generating, by the artificial intelligence agent and using the image data, quality scores for completed instances of the work task corresponding to ones of the plurality of entries.
Clause 77: The method of any clause herein, further comprising the artificial intelligence agent updating criteria for determining quality scores using unsupervised machine learning.
Clause 78: The method of any clause herein, generating, using the artificial intelligence agent and haptic feedback data and quality scores accessed from the plurality of entries of the database, directions for performing the work task; and
   transmitting, by the artificial intelligence agent and concurrent with the optimized operating parameters, the directions for performing the task to a computing device associated with an entity performing of the subsequent instance of the work task.
Clause 79: The method of any clause herein, further comprising:
   generating, by the artificial intelligence agent based on the haptic feedback data and quality scores accessed from the plurality of entries, audio-visual data; and
   transmitting, by the artificial intelligence agent and concurrent with the optimized operating parameters, the audio-visual data to a computing device associated with an entity performing of the subsequent instance of the work task.
Clause 80: A system comprising:
   a computer system including one or more processors and a non-transitory computer-readable medium storing instructions that, when executed by the one or more processors, cause the computer system to:
   access, from a plurality of entries of a database and using an artificial intelligence agent, quality scores and haptic feedback data, wherein each of the quality scores is indicative of a quality of a completed instance of a work task, and wherein haptic feedback data stored in ones of the plurality of entries comprises one or more parameters;
   generate, using the artificial intelligence agent and based on haptic feedback data and quality scores accessed from the plurality of entries, optimized operating parameters for performing a subsequent instance of a work task; and
   transmit the optimized operating parameters to a haptic device used in and during the performing of the subsequent instance of the work task.
Clause 81: The system of any clause herein, wherein the instructions are further executable by the one or more processors to cause the artificial intelligence agent to:
   generate updated ones of the optimized operating parameters based on haptic feedback data and quality scores corresponding to one or more subsequent completed instances of the work task; and
   transmit the updated ones of the optimized operating parameters to the haptic device used in and during the subsequent instance of performing the work task.
Clause 82: The system of any clause herein, wherein the optimized operating parameters include information indicative of an orientation of a tool used in performing the work task.
Clause 83: The system of any clause herein, wherein the optimized operating parameters include a value of voltage provided to a tool used in performing the work task.
Clause 84: The system of any clause herein, wherein the optimized operating parameters include a value of an electrical current provided to a tool used in performing the work task.
Clause 85: The system of any clause herein, wherein the optimized operating parameters include a value of a temperature of generated by a tool used in performing the work task.
Clause 86: The system of any clause herein, wherein the optimized operating parameters include one or more vibrations that provide guidance to an entity for performing the work task.
Clause 87: The system of any clause herein, wherein the instructions are executable by the one or more processors to cause the computer system to:
   generate, using the artificial intelligence agent and haptic feedback data and quality scores accessed from the plurality of entries of the database, directions for performing the work task; and
   transmit, by the artificial intelligence agent and concurrent with the optimized operating parameters, the directions for performing the task to a computing device associated with an entity performing of the subsequent instance of the work task.
Clause 88: The system of any clause herein, wherein the instructions are executable by the one or more processors to cause the computer system to generate, by the artificial intelligence agent and using the image data, quality scores for completed instances of the work task corresponding to ones of the plurality of entries.
Clause 89: The system of any clause herein, wherein the instructions are executable by the one or more processors to cause the computer system to update criteria for determining the quality scores, by the artificial intelligence agent, using unsupervised machine learning.
Clause 90: The system of any clause herein, wherein the instructions are executable by the one or more processors to cause the computer system to:
   generate, by the artificial intelligence agent based on the haptic feedback data and quality scores accessed from the plurality of entries, audio-visual data; and
   transmit, by the artificial intelligence agent and concurrent with the optimized operating parameters, the audio-visual data to a computing device associated with an entity performing of the subsequent instance of the work task.
Clause 91: A non-transitory computer-readable medium storing instruction thereon that, when executed by one or more processors of a computer system, cause the computer system to:
   access, from a plurality of entries of a database and using an artificial intelligence agent, quality scores and haptic feedback data, wherein each of the quality scores is indicative of a quality of a completed instance of a work task, and wherein haptic feedback data stored in ones of the plurality of entries comprises one or more parameters;
   generate, using the artificial intelligence agent and based on haptic feedback data and quality scores accessed from the plurality of entries, optimized operating parameters for performing a subsequent instance of a work task;
   transmit the optimized operating parameters to a haptic device used in and during the performing of the subsequent instance of the work task.
Clause 92: The non-transitory computer-readable medium of any clause herein, wherein the instructions are further executable to cause the computer system to:
   generate, by the artificial intelligence agent, updated ones of the optimized operating parameters based on haptic feedback data and quality scores corresponding to one or more subsequent completed instances of the work task; and
   transmit the updated ones of the optimized operating parameters to the haptic device used in and during the subsequent instance of performing the work task.
Clause 93: The non-transitory computer-readable medium of any clause herein, wherein the instruction are further executable to cause the computer system to:
   generate, by the artificial intelligence agent based on the haptic feedback data and quality scores accessed from the plurality of entries, audio-visual data; and
   transmit, by the artificial intelligence agent and concurrent with the optimized operating parameters, the audio-visual data to a computing device associated with an entity performing of the subsequent instance of the work task.
Clause 94: The non-transitory computer-readable medium of any clause herein, wherein the instructions are further executable to cause the computer system to:
   generate, using the artificial intelligence agent and haptic feedback data and quality scores accessed from the plurality of entries of the database, directions for performing the work task; and
   transmit, by the artificial intelligence agent and concurrent with the optimized operating parameters, the directions for performing the task to a computing device associated with an entity performing of the subsequent instance of the work task.
Clause 95: The non-transitory computer-readable medium of any clause herein, wherein the optimized operating parameters include one or more of the following:
   information indicative of an orientation of a tool used in performing the work task;
   a value of voltage provided to the tool used in performing the work task;
   a value of an electrical current provided to the tool used in performing the work task;
   a value of a temperature of generated by the tool used in performing the work task;
   one or more vibrations that provide guidance to a user for performing the work task.
Clause 96: The non-transitory computer-readable medium of any clause herein, wherein the instructions are further executable to cause the computer system to generate, by the artificial intelligence agent and using the image data, quality scores for completed instances of the work task corresponding to ones of the plurality of entries.
Clause 97: The non-transitory computer-readable medium of any clause herein, wherein the instructions are further executable to cause the computer system to update criteria for determining the quality scores, by the artificial intelligence agent, using unsupervised machine learning
Clause 98: A system comprising:
   a database having a plurality of entries, wherein the database is configured to receive and store, in ones of the plurality of entries, haptic feedback data and an associated quality scores for a corresponding instance of a work task performed using a haptic device, wherein quality score is indicative of a quality of results of a corresponding instance of the work task upon completion;
   one or more processors; and
   a non-transitory computer readable medium storing instructions that, when executed by the one or more processors execute an artificial intelligence agent, wherein the artificial intelligence agent, when executed by the one or more processors, is configured to generate optimized haptic feedback parameters based on haptic feedback data and quality scores stored in various ones of the plurality of entries of the data base;
   wherein the instructions further executable by the one or more processor to cause the optimized operating parameters to be transmitted to the haptic device during a subsequent instance of performing the work task.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

1. A method comprising:
accessing, from a plurality of entries of a database and using an artificial intelligence agent, quality scores and haptic feedback data, wherein each of the quality scores is indicative of a quality of a completed instance of a work task, and wherein haptic feedback data stored in ones of the plurality of entries comprises one or more parameters;
generating, using the artificial intelligence agent and based on haptic feedback data and quality scores accessed from the plurality of entries, optimized operating parameters for performing a subsequent instance of a work task; and
transmitting the optimized operating parameters to a tool used in and during the performing of the subsequent instance of the work task.

2. The method of claim 1, wherein the optimized operating parameters include one or more of the following:
information indicative of an orientation of a tool used in performing the work task;
a value of voltage provided to a tool used in performing the work task;
a value of an electrical current provided to a tool used in performing the work task;
a value of a temperature of generated by a tool used in performing the work task; and
one or more vibrations that provide guidance to an entity for performing the work task.

3. The method of claim 1, further comprising repeating, using the artificial intelligence agent, the generating of the optimized operating parameters based on haptic feedback data and quality scores corresponding to one or more subsequent completed instances of the work task.

4. The method of claim 3, wherein the tool is a haptic device, and wherein the method further comprises transmitting updated ones of the optimized operating parameters to the haptic device used in and during the subsequent instance of performing the work task.

5. The method of claim 1, further comprising:
accessing, by the artificial intelligence agent, image data stored in ones of the plurality of entries, wherein the image data stored in a particular one of the plurality of entries corresponds to a completed instance of the work task; and
generating, using the image data by the artificial intelligence agent, the optimized operating parameters for performing a subsequent instance of a work task.

6. The method of claim 5, further comprising generating, by the artificial intelligence agent and using the image data, quality scores for completed instances of the work task corresponding to ones of the plurality of entries.

7. The method of claim 6, further comprising the artificial intelligence agent updating criteria for determining quality scores using unsupervised machine learning.

8. The method of claim 1, further comprising:
generating, using the artificial intelligence agent and haptic feedback data and quality scores accessed from the plurality of entries of the database, directions for performing the work task; and
transmitting, by the artificial intelligence agent and concurrent with the optimized operating parameters, the directions for performing the work task to a computing device associated with an entity performing of the subsequent instance of the work task.

9. The method of claim 1, further comprising:
generating, by the artificial intelligence agent based on the haptic feedback data and quality scores accessed from the plurality of entries, audio-visual data; and
transmitting, by the artificial intelligence agent and concurrent with the optimized operating parameters, the audio-visual data to a computing device associated with an entity performing of the subsequent instance of the work task.

10. A system comprising:
a computer system including one or more processors and a non-transitory computer-readable medium storing instructions that, when executed by the one or more processors, cause the computer system to:
access, from a plurality of entries of a database and using an artificial intelligence agent, quality scores and haptic feedback data, wherein each of the quality scores is indicative of a quality of a completed instance of a work task, and wherein haptic feedback data stored in ones of the plurality of entries comprises one or more parameters;
generate, using the artificial intelligence agent and based on haptic feedback data and quality scores accessed from the plurality of entries, optimized operating parameters for performing a subsequent instance of a work task; and
transmit the optimized operating parameters to a haptic device used in and during the performing of the subsequent instance of the work task.

11. The system of claim 10, wherein the instructions are further executable by the one or more processors to cause the artificial intelligence agent to:
generate updated ones of the optimized operating parameters based on haptic feedback data and quality scores corresponding to one or more subsequent completed instances of the work task; and
transmit the updated ones of the optimized operating parameters to the haptic device used in and during the subsequent instance of performing the work task.

12. The system of claim 10, wherein the optimized operating parameters include:
information indicative of an orientation of a tool used in performing the work task;
a value of voltage provided to a tool used in performing the work task;
a value of an electrical current provided to a tool used in performing the work task a value of a temperature of generated by a tool used in performing the work task; and
one or more vibrations that provide guidance to an entity for performing the work task.

13. The system of claim 10, wherein the instructions are executable by the one or more processors to cause the computer system to:
generate, using the artificial intelligence agent and haptic feedback data and quality scores accessed from the plurality of entries of the database, directions for performing the work task; and
transmit, by the artificial intelligence agent and concurrent with the optimized operating parameters, the directions for performing the work task to a computing device associated with an entity performing of the subsequent instance of the work task.

14. The system of claim 10, wherein the instructions are further executable by the one or more processors to cause the artificial intelligence agent to:
access, by the artificial intelligence agent, image data stored in ones of the plurality of entries, wherein the image data stored in a particular one of the plurality of entries corresponds to a completed instance of the work task; and
generate, using the image data by the artificial intelligence agent, the optimized operating parameters for performing a subsequent instance of a work task wherein the instructions are executable by the one or more processors to cause the computer system to generate, by the artificial intelligence agent and using image data, quality scores for completed instances of the work task corresponding to ones of the plurality of entries.

15. The system of claim 14, wherein the instructions are executable by the one or more processors to cause the computer system to update criteria for determining the quality scores, by the artificial intelligence agent, using unsupervised machine learning.

16. The system of claim 10, wherein the instructions are executable by the one or more processors to cause the computer system to:
generate, by the artificial intelligence agent based on the haptic feedback data and quality scores accessed from the plurality of entries, audio-visual data; and
transmit, by the artificial intelligence agent and concurrent with the optimized operating parameters, the audio-visual data to a computing device associated with an entity performing of the subsequent instance of the work task.

17. A non-transitory computer-readable medium storing instruction thereon that, when executed by one or more processors of a computer system, cause the computer system to:
access, from a plurality of entries of a database and using an artificial intelligence agent, quality scores and haptic feedback data, wherein each of the quality scores is indicative of a quality of a completed instance of a work task, and wherein haptic feedback data stored in ones of the plurality of entries comprises one or more parameters;
generate, using the artificial intelligence agent and based on haptic feedback data and the quality scores accessed from the plurality of entries, directions for performing a subsequent instance of the work task and optimized operating parameters for performing the subsequent instance of the work task;
transmit the optimized operating parameters to a haptic device used in and during the performing of the subsequent instance of the work task and the directions for performing the work task to a computing device associated with an entity performing of the subsequent instance of the work task; and
updating, using the artificial intelligence agent and using unsupervised machine learning, criteria for determining the quality scores.

18. The computer-readable medium of claim 17, wherein the instructions are further executable to cause the computer system to:
generate, by the artificial intelligence agent, updated ones of the optimized operating parameters based on haptic feedback data and the quality scores corresponding to one or more subsequent completed instances of the work task; and
transmit the updated ones of the optimized operating parameters to the haptic device used in and during the subsequent instance of performing the work task.

19. The computer-readable medium of claim 17, wherein the instructions are further executable to cause the computer system to:
generate, by the artificial intelligence agent based on the haptic feedback data and the quality scores accessed from the plurality of entries, audio-visual data; and
transmit, by the artificial intelligence agent and concurrent with the optimized operating parameters, the audio-visual data to a computing device associated with an entity performing of the subsequent instance of the work task.

20. The computer-readable medium of claim 17, wherein the optimized operating parameters include:
information indicative of an orientation of a tool used in performing the work task;
a value of voltage provided to a tool used in performing the work task;
a value of an electrical current provided to a tool used in performing the work task a value of a temperature of generated by a tool used in performing the work task; and
one or more vibrations that provide guidance to an entity for performing the work task.
